(19) United States
(12) Patent Application Publication
(10) Pub. No.: US 2025/0379697 A1
(43) Pub. Date: Dec. 11, 2025

(54) UPLINK INTER-CELL INTERFERENCE IDENTIFICATION AND OPTIMIZATION IN A RADIO ACCESS NETWORK

(71) Applicant: Dell Products L.P., Round Rock, TX (US)

(72) Inventors: Eran Goldstein, Montreal (CA); Mohammed Abdelsadek, Kanata (CA); Jayaram Venguduswamy Srinivasan, Nepean (CA); Ravi Sharma, Cupertino, CA (US)

(21) Appl. No.: 18/734,827

(22) Filed: Jun. 5, 2024

(51) Int. Cl. H04L 5/00; H04W 72/0453; H04W 72/542

(52) U.S. Cl. CPC H04L 5/0051; H04W 72/0453; H04W 72/542

(57) ABSTRACT

The described technology is generally directed towards identifying and mitigating interference in a radio access network (RAN) network. Various embodiments are presented to identify first uplink signals generated by a first user equipment (UE) causing interference of second uplink signals generated by a second UE. The first UE is being served by a first base station while the second UE is served by a second base station, however, the first uplink signals from the first UE are also being received at the second base station. Reference signals can be transmitted by the various base stations across the RAN to determine which UEs are in transmission and reception range of the respective base stations. A list of base stations seen by an interfering UE can be subsequently utilized to control transmission of a sounding reference signal(s) and based thereon, determination of which frequency sub-bands are affected by the interfering UE.

### BACKGROUND

Radio access networks (RANs) provide wide-area wireless connectivity to mobile devices. A RAN can be constructed from devices manufactured by disparate vendors. Given the potentially vast scale and complexity of RANs developed to meet the ever-increasing demand for cellular communications, various vendor consortiums have been formed with a view to generating specifications to facilitate configurations, techniques, methods, equipment, etc., for respective communications on a RAN. Such consortiums include the Third Generation Partnership Project (3GPP) incorporating Long-Term Evolution Fourth Generation (LTE 4G), Fifth Generation/New Radio (5G, 5G/NR), and most recently, the Open-Radio Access Network (O-RAN).

To meet the demands of 5G traffic, technologies such as enhanced mobile broadband (eMBB), massive machine-type communication (mMTC), and ultra-reliable low-latency communication (URLLC) have been developed, in conjunction with a requirement for a frequency reuse factor of one, rendering 5G networks to be signal dense compared to legacy/prior systems. However, with such information dense networks, signal interference between respective user devices can be heightened, and potentially problematic.

The above-described background is merely intended to provide a contextual overview of some current issues and is not intended to be exhaustive. Other contextual information may become further apparent upon review of the following detailed description.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. The sole purpose of the Summary is to present some concepts of the disclosure in a streamlined form as a prelude to the more detailed description that is presented later.

In one or more embodiments described herein, systems, devices, computer-implemented methods, configurations, apparatus, and/or computer program products are presented to identify and mitigate signal interference on a RAN. By centralizing information regarding which base stations and user equipment are within communication range of each other, candidate interfering user equipment can be identified, the centralized information can be further implemented with various operations available to mitigate the interference.

According to one or more embodiments, a system is presented, wherein the system comprises a distribution unit (DU) deployable in a radio access network. The system comprising at least one processor, and at least one memory coupled to the at least one processor and having instructions stored thereon, wherein the system can be configured to identify occurrence of interference and further mitigate at least one effect of the interference. In response to the at least one processor executing the instructions, the instructions facilitate performance of operations, comprising receiving a first sounding reference signal (SRS) at a first base station, wherein the first SRS can be transmitted by a first user equipment (UE), the first UE can be being served by the first base station and the first SRS can be scheduled to be transmitted at a time when a second UE is instructed not to transmit a signal, and further receiving a second SRS at the first base station, wherein the second SRS can be transmitted by the first UE and the second SRS can be scheduled for transmission at the same time as a third SRS can be transmitted from the second UE. In an embodiment, the operations can further comprise determining that a first magnitude of a first resource block in the second SRS is less than a second magnitude of a second resource block in the first SRS, further comparing the first magnitude of the first resource block in the second SRS with a threshold value, and further, in response to determining the first magnitude of the first resource block in the second SRS is less than the threshold value, instructing the first UE to transmit an uplink signal, wherein the uplink signal does not comprise data being transmitted in the first resource block. In an embodiment, the second UE can be served by a second base station, and wherein the first base station and second base station are disparate base stations. In another embodiment, the first base station can be communicatively coupled to the DU, and wherein the second base station is communicatively coupled to the DU.

In an embodiment, the operations can further comprise, in response to determining that the first magnitude of the first resource block in the second SRS is equal to or greater than the threshold value, instructing the first UE to transmit the uplink signal, wherein the uplink signal comprises data being transmitted in the first resource block.

In an embodiment, the operations can further comprise, prior to receiving the first SRS, instructing a group of base stations communicatively coupled to the DU to respectively transmit a reference downlink signal, and further receiving a reference signal received power (RSRP) list from the second UE, wherein the RSRP list comprises a first signal strength of a first downlink signal generated by the first base station and a second signal strength of a second downlink signal generated by the second base station. In another embodiment, the operations can further comprise determining that the second UE is included in the RSRP list, wherein inclusion of the second UE in the RSRP list indicates that the second UE is in range of the first base station, and in response to determining the second UE is included in the RSRP list, instructing the second UE to transmit the third SRS when the first UE transmits the second SRS at the first base station.

In an embodiment, the RSRP list ranks the first base station and the second base station based on the first signal strength of the first downlink signal and the second signal strength of the second downlink signal, and wherein the first signal strength of the first downlink is greater than the second signal strength of the second downlink signal.

In an embodiment, the DU can be located in a first data server and communicatively coupled to a second data server, and wherein the first base station can be communicatively coupled to the first data server via the second data server.

In another embodiment, the operations can further comprise determining a modulation and coding scheme (MCS) score for a portion of a frequency spectrum included in the second SRS, further identifying an MCS corresponding to the MCS score, and further instructing the second UE to transmit an uplink signal utilizing the MCS.

In further embodiments, a computer-implemented method is provided, wherein the method comprises receiving, by a device comprising at least one processer, a reference signal received power (RSRP) list representing a set of base stations within communication range of a first user equipment (UE), wherein the RSRP list is received via a first base station serving the first UE, further identifying, by the device, a second base station in the RSRP list, and further, in response to identifying the second base station, identifying, by the device, a second UE being served by the second base station.

In another embodiment, the operations can further comprise instructing, by the device, the second UE to transmit a first sounding reference signal (SRS), wherein the first UE is not scheduled to transmit an uplink signal during transmission of the first SRS, further instructing, by the device, the second UE to transmit a second SRS and the first UE to transmit a third SRS, wherein transmission of the second SRS is scheduled to coincide with transmission of the third SRS, and further determining, by the device, whether operation of the first UE is interfering with operation of the second UE.

In a further embodiment, the operations can further comprise determining, by the device, a first signal to noise ratio (SNR) of a portion of a first frequency spectrum included in the second SRS, further comprise comparing, by the device, the first SNR with a threshold SNR, and further comprise, in response to a determination that the first SNR is less than the threshold SNR, instructing, by the device, the second UE not to transmit data in the portion of the first frequency spectrum.

In a further embodiment, the operations can further comprise, in response to a determination that the first SNR is equal to or greater than the threshold SNR, instructing, by the device, the second UE to transmit data in the portion of the first frequency spectrum.

In another embodiment, the operations can further comprise determining, by the device, a modulation and coding scheme (MCS) score for a portion of a first frequency spectrum included in the second SRS, further identifying, by the device, an MCS corresponding to the MCS score, and further instructing, by the device, the second UE to transmit an uplink signal utilizing the MCS. In an embodiment, the MCS specifies one of quadrature amplitude modulation or quadrature phase shift keying.

Further embodiments can include a computer program product stored on a non-transitory computer-readable medium and comprising machine-executable instructions, wherein in response to being executed, the machine-executable instructions cause a system that is part of a radio access network (RAN) to perform operations, comprising receiving, from a first user equipment (UE), an RSRP list, wherein RSRP list is representative of a group of base stations within communication range the first UE, further identifying that the group of base stations comprises a first base station and a second base station, wherein the RSRP list is received via the first base station, and wherein the first base station is serving the first UE, and further determining, based on inclusion of the second base station in the RSRP list, that the first UE is within uplink signal communication range of the second base station. In an embodiment, the system is a distributed unit communicatively coupled to the first base station and the second base station.

In another embodiment, the operations can further comprise (a) identifying a second UE communicatively coupled to the second base station; (b) receiving, via the second base station, a first SRS generated by the second UE, wherein the first SRS was scheduled for transmission when the first UE is not transmitting an uplink signal; (c) receiving, via the second base station, a second SRS generated by the second UE, wherein the second SRS is transmitted at a same time as an uplink signal is transmitted by the first UE to the first base station; (d) comparing first content of the first SRS with second content of the second SRS; and (e) determining, based on the first content of the first SRS being determined to be different from the second content of the second SRS, that uplink signaling performed by the first UE is interfering with uplink signaling performed by the second UE.

In another embodiment, the operations can further comprise determining, based on the first content of the first SRS being determined to be same content as the second content of the second SRS, that uplink signaling performed by the first UE is not interfering with uplink signaling performed by the second UE.

In another embodiment, the operations can further comprise determining a signal to noise ratio (SNR) of a portion of a frequency band in the second SRS, and in response to determining the SNR of the portion of the frequency band is less than a defined threshold, instructing the second UE not to subsequently transmit data using the portion of the frequency band.

In another embodiment, the operations can further comprise determining a modulation and coding scheme (MCS) score for the second SRS, further identifying an MCS assigned to the MCS score, and further instructing the second UE to implement the MCS for transmission of data in an uplink signal.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates a radio access network (RAN) configured to identify and mitigate uplink interference, in accordance with one or more embodiments.

FIGS. 2A and 2B illustrate signal quality determination being performed with (a) a scheduled sounding reference signal (SRS) transmitted from a single UE (FIG. 2A); in conjunction with (b) a scheduled SRS from the single UE transmitted concurrently with uplink signals/SRSs transmitted by other UEs (FIG. 2B), in accordance with one or more embodiments.

FIG. 3 presents a system where uplink signals received at a group of base stations are combined to compile data that would not be possible when sourcing data from a single base station, in accordance with an embodiment.

FIG. 4 illustrates various components and systems to determine and mitigate interference in a RAN comprising a collection of data servers, associated DUs, base stations, etc., in accordance with an embodiment

FIGS. 5A and 5B present a computer-implemented method for determining potential for signals generated by a first UE interfering with signals generated by at least one other UE, in accordance with an embodiment.

FIG. 6 presents a computer-implemented method for determining sub-bands to transmit data in uplink signals, in accordance with an embodiment.

FIG. 7 presents a computer-implemented method for determining application of a modulation and coding scheme (MCS) to transmit data in uplink signals, in accordance with an embodiment.

FIG. 8 presents a computer-implemented method for mitigating interference of uplink signals, in accordance with an embodiment.

FIG. 9 illustrates a block flow diagram for a system associated with identifying and mitigating interference of uplink signals on a RAN, in accordance with one or more embodiments presented herein.

FIG. 10 illustrates a block flow diagram for a process associated with identifying and mitigating interference of uplink signals on a RAN, in accordance with one or more embodiments presented herein.

FIG. 11, illustrates a block flow diagram for a process associated with identifying and mitigating interference of uplink signals on a RAN, in accordance with one or more embodiments presented herein.

FIG. 12 illustrates an example wireless communication system, in accordance with one or more embodiments described herein.

FIG. 13 presents an example environment for implementing various embodiments presented herein.

FIG. 14 presents a schematic illustrating a high-level depiction of the problem of interference of uplink signals.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is to be appreciated, however, that the various embodiments can be practiced without these specific details, e.g., without applying to any particular networked environment or standard. In other instances, well-known structures and devices are shown in block diagram form in order to facilitate describing the embodiments in additional detail.

### Abbreviations/Terms

BLER—Block Error Rate: ratio of number of erroneous blocks of data versus the total number of blocks transmitted over a certain number of frames. In a use case example, 5G ultra-reliable low latency (URLLC) applications that are highly sensitive to latency can have a target BLER between 10⁻⁹ and 10⁻⁵ for latency <1 msec versus a typical value of 10⁻² in LTE system. A threshold BLER can be implemented at the physical layer of 5G/LTE, where, for example, ≤10% BLER is acceptable. For a BLER >10%, a less efficient MCS is utilized, which can increase data redundancy and reduces the spectral efficiency for reliable data transfer.
Base Station—the term base station is use interchangeably herein. For example, a base station can comprise a cell tower at which communications equipment (e.g., transmitter/receiver equipment), signal processing equipment, and antennae (e.g., directional, array, beam, and such), to serve a cell region. A base station can further include RU equipment, one or more DU's, data servers, and such. Accordingly, per the various embodiments presented herein, control provided/processing by a DU operating on a server can be located at a base station. Alternatively, the DU can be remotely located from the base station. Per the various embodiments presented herein, a single DU (e.g., at a data server) can be communicatively coupled to two or more base stations at the same time, such that, knowledge acquired (e.g., re uplink signaling by multiple UEs) across the two or more base stations can be combined and processed at the DU. Further, by having data servers in close proximity (e.g., regarding signal latency), first signals/information/data processed by one or more base stations communicatively coupled to a first data server can be shared/accessed by a DU located on a second data server.
CU—central unit: configured to centralize RAN packet processing functions.
DL—Downlink/downlink signal: signaling from a base station to a UE.
DMRS—Demodulation Reference Signal: can be utilized for channel estimation and demodulation of associated physical channels, as well as determining received signal power.
DU—Distributed Unit: configured to conduct baseband processing functions across base stations/cell sites, e.g., control operation of, and signaling at base stations.
gNodeB—Next-Generation node B: responsible for radio communication with UEs in the coverage area, known as a cell. A gNodeB can be a physical entity such as a cell tower, or a virtual entity, such as a software defined radio (SDR). The terms gNodeB, node, and base station are used interchangeably herein.
LAYER 1: physical layer interfaces, RUs, and such, at a RAN.
Multi-TRP: multiple transmission and reception points (multi-TRPs) are being developed to improve reliability, coverage, and capacity performance through flexible deployment scenarios. Access networks can comprise multi-TRPs (i.e., macro-cells, small cells, pico-cells, femto-cells, remote radio heads, relay nodes, etc.). UEs on a cell-edge are typically served with a low quality-of-Service (QOS) due to the comparatively long distance from the base station and unfavorable channel conditions (e.g., intercell interference (ICI) from neighboring base stations/UEs). A UE at the cell edge can be served by multi-TRPs to improve signal transmission/reception, resulting in increased data throughput.
NR—New Radio.
MCS—Modulation and Coding Scheme: cellular networks can utilize different modulation schemes with corresponding codes rates. For example, quadrature amplitude modulation (QAM) is a high-bandwidth method of modulation, encoding data by adjusting both the amplitude and the phase of a signal at the same time, with common QAM's being 16 QAM (4 bits/values), 64 QAM (6 bits/values), 256 QAM (8 bits/values). Another MCS is quadrature phase shift keying (QPSK) (2 bits/values). The foregoing code rates define the proportion of bits transmitted that are useful, and can be computed as the ratio of useful bits by total bits that are transmitted. The higher the value of an MCS score/value, the higher the spectral efficiency and greater data throughput, e.g., more data bits packed per resource element over a clean channel or high SINR channel conditions.
PUCCH—Physical Uplink Control Channel: a physical channel(s) designed to carry UCI (uplink control information).
PUSCH—Physical Uplink Shared Channel: used to transmit uplink shared channel (UL-SCH) and layer 1 (L1) and layer 2 (L2) control information. The UL-SCH is the transport channel used for transmitting uplink data (a transport block).
RB—Resource Block: in 5G, one NR RB can contain 12 sub-carriers in a frequency domain similar to LTE. In LTE, RB bandwidth is fixed to 180 kHz but in NR, RB bandwidth is not fixed and depends on sub-carrier spacing.
RSRP—Reference Signal Received Power: signal strength of a reference signal received at a UE from a base station. Example reference signals include, in a non-limiting list: CSI-RS, PDSCH DMRS (PDSCH demodulation), PUSCH DMRS (PUSCH demodulation), PUCCH DMRS (PUCCH demodulation), SRS (sounding reference signal), PBCH DMRS (PBCH demodulation), PTRS (phase tracking for PDSCH), TRS (time tracking), etc. In an aspect, an RSRP list can be generated comprising respective RSRPs of respective base stations.
RU—Radio Unit: provide radio functions at antenna sites. While the RUs are located at antenna sites, the locations of CUs and DUs are not fixed to any particular geographic area or site. DUs can be co-located with RUs local to an antenna, also DUs can be located many miles from RUs, whereby connection between the DUs and RUs is by any suitable technology, e.g., fiber optics. CUs and DUs can be located “in the cloud”, such as at a data center which may or may not be proximal to the RU
SNR—Signal-to-noise Ratio: difference between the received signal power versus the noise power, and provides a measure of radio quality. The poorer the ratio becomes, the greater the possibility of data corruption and retransmission of data.
SINR—Signal-to-Interference-and-noise Ratio: difference between the received signal power versus the interference and noise power, and provides a measure of radio quality. The poorer the ratio becomes, the greater the possibility of data corruption and retransmission of data. Retransmissions cause degradation in Layer 1/physical layer throughput and prolonged transmission latency of communications.
SRS—Sounding Reference Signal: a reference signal utilized (e.g., by eNodeB) to determine the channel/signal quality of an uplink signal/path for each sub-band of a signal frequency spectrum.
TPC—Transmit Power Control: transmit power is the amount of radio frequency energy given out by a UE, TPC involves an access point (e.g., RU at a base station) defining local parameters for maximum transmit power. TPC can be configured to reduce the power of a radio transmitter to the minimum required to maintain a communication link within a certain signal quality. TPC can also be utilized to avoid interference with other devices.
UE—User Equipment: mobile phone, laptop computer, and such.
UL—Uplink/uplink signal-signaling from a UE to a cell tower.
n is any positive integer.

Numbering herein takes the form of 100A-n, however, to indicate more than one of an aspect, signals, etc., may be labeled as XXXA1, XXXA2, etc., such as a first reference signal directed to UE 140A is labelled as 128A1, a second reference signal directed to UE 140A is labelled as 128A2, and such.

### 1. OVERVIEW

As the amount of signaling/data communicated across a 5G NR network increases, the potential for signal interference increases. Uplink interference restricts the performance of networks, rendering the networks to be interference limited. While various techniques and procedures have been developed to manage interference issues, uplink interference cannot be avoided, particularly for UEs located at a cell-edge. UEs at a cell-edge are distant from the base station serving the UE, and are prone to interference from uplink signals generated by other UEs that are not being served by the base station. Where two or more UEs are being served by the same base station, the base station can schedule uplink signal transmissions from the respective UEs to prevent uplink signals to be broadcast at the same time. However, with conventional systems, such coordinated scheduling is not possible with UEs transmitting to/served by disparate base stations.

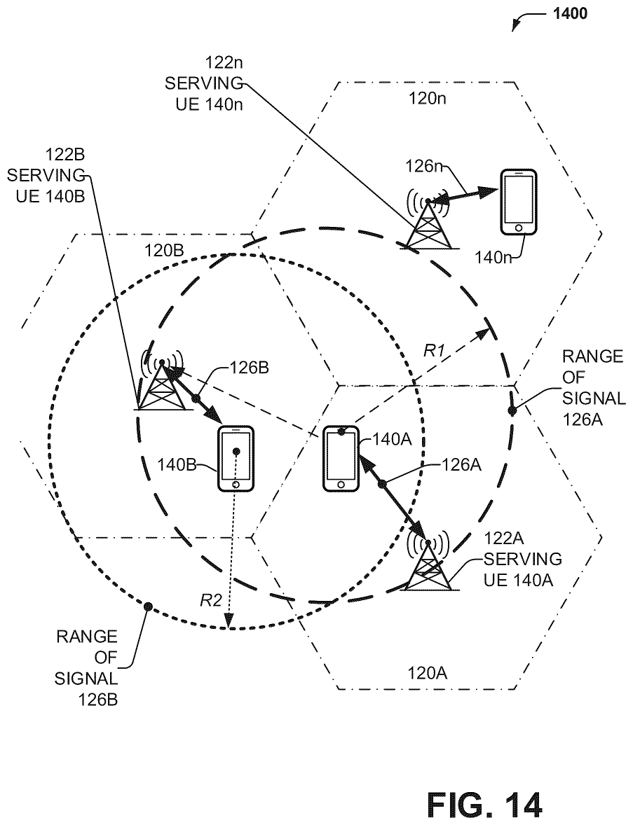

Turning momentarily to FIG. 14, schematic 1400 provides a high-level depiction of the problem of uplink signal interference. As shown, a first UE 140A is transmitting/broadcasting uplink signals 126A having a transmission range of R1, wherein signaling from first UE 140A is being served by first base station 122A in cell 120A. Further, a second UE 140B is transmitting/broadcasting uplink signals 126B having a transmission range of R2, wherein signaling from the second UE 140B is being served by second base station 122B in cell 120B. Further, a third UE 140n is transmitting/broadcasting uplink signals 126n, wherein signaling from the third UE 140n is being served by third base station 122n in cell 120n.

With UE 140A being located near the edge of cell 120A, uplink signals 126A being broadcast by UE 140A reach first base station 122A and also have sufficient transmission power/range R1 to be received at the second base station 122B, potentially causing interference with uplink signals 126B being received at second base station 122B. However, uplink signals 126A being broadcast by UE 140A do not have sufficient transmission range to reach third base station 122n, with third uplink signals 126n received at third base station 122n from UE 140n not being susceptible to interference from first uplink signals 126A.

Frequently, the DU hardware of different base stations/cells is in close proximity to one another or the base stations may use the same hardware. The various embodiments presented herein relate to exploiting the possibility of fast low latency data exchange between schedulers of different cells (e.g., connected to a common DU) while maintaining the current architecture of an independent scheduler (e.g., in a signal component) per cell, to improve handling of the uplink interference.

With a conventional system, an uplink SRS transmitted from a UE is generally processed only by the base station serving the UE, wherein determination of which base station serves the UE can be established by analysis of signal strength of respective signals (e.g., synchronization signals) received at the UE from respective base stations within communication range of the UE. Hence, with conventional technologies and techniques, it is not possible to identify a first UE causing signaling interference to a second UE serviced by another cell (e.g., an adjacent cell) as the base station serving a UE is determined at the UE level of the RAN. Accordingly, while classical/conventional techniques are available to determine/address a cause of interference at a base station, the techniques are limited by the lack of knowledge regarding an interfering UE. Such available classical/conventional techniques/technologies include equalization with interference rejection combining (IRC).

Interference between uplink signals generated by disparate UEs can be problematic owing to the various uplink signals sharing the same frequency spectrum, with scheduling of uplink signals being largely random across the disparate base stations. As further described, respective sub-bands/resource blocks can be selected/deselected to enable a first UE to send data in a first set of uplink signals while a second UE sends data in a second set of uplink signals, whereby frequency sub-bands selected for use in the first set of uplink signals are different to frequency sub-bands selected for use in the second set of uplink signals. Also, application of an MCS can be determined, in accordance with the level of interference, SNR, SINR, etc., being encountered by a UE/base station.

Per the various embodiments presented herein, systems, technologies, techniques, and/or methods, are utilized to identify candidate interfering UEs and further mitigate uplink interference, in particular with regard to a network architecture comprising a distributed unit(s) (DUs) configured to serve base stations operating in multiple neighbor/adjacent cells to the base station undergoing interference from a candidate interfering UE.

### 2. BRIEF REVIEW OF EMBODIMENTS

The following, (A)-(D), presents a summary of the various embodiments presented herein:
A) identify a candidate UE that is potentially interfering with the operation of one or more other UEs/non-serving base stations, e.g., utilizing the RSRP measurements of the UEs.
B) transmit, from the candidate UE, an uplink sounding reference signal (SRS) to determine base stations in range of the UE. Transmission of an SRS can be in accordance with a scheduled transmission sequence.
C) configure a DU to process SRSs received from candidate interfering UEs. In an embodiment, the DU is communicatively coupled to the respective base stations/Layer 1 of the different cells potentially affected by interference from the candidate UE.
D) based on the measurements at each base station, determine the interfering UE(s) of each cell/base station and an interfering domain(s) of the interfering UE(s), e.g., the parts of the spectrum (frequency spectrum sub-band/resource blocks) or the spatial directions having a high interference level.

The gathered measurements and information can be utilized to mitigate the interference or reduce its impact, per the following:
i) a scheduler, e.g., in a signal component at the DU and/or at a base station, can utilize the respective measurements, etc., while allocating the radio resources/signaling at a UE, utilizing low-complexity techniques and systems.
ii) the DU/RU can be configured to adjust the precoding and beamforming to minimize the interference from the interfering UEs.
iii) the DU/RU can establish a cooperative service with those UEs utilizing multiple access points/RUs/base stations.

### 3. SIGNAL INTERFERENCE IN A RAN

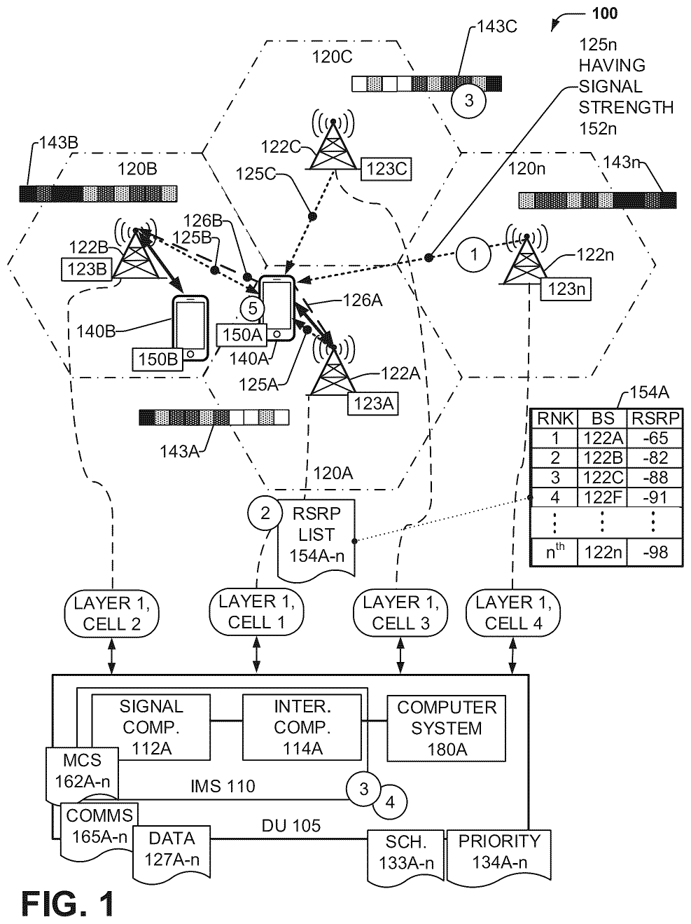

FIG. 1, schematic 100, illustrates a radio access network (RAN) configured to identify and mitigate uplink interference, in accordance with one or more embodiments. RAN 100 comprises a series of cells 120A-n, wherein, each cell 120A-n includes a base station 122A-n (e.g., a signal transmission tower, a cell tower, node, access point, and such). The respective cells 120A-n (e.g., communication regions) and base stations 122A-n are communicatively coupled to a distributed unit (DU) 105. DU 105 can be configured to control operation of/signaling at the respective base stations 122A-n and the respective cells 120A-n serviced by a respective base station 122A-n, e.g., at Layer 1 of RAN 100. As shown, DU 105 can be coupled to all of the base stations 122A-n, such that, as further described, a DU 105 can process data/information 127A-n regarding signaling by UEs 140A-n at the base stations 122A-n connected to the DU 105.

DU 105 can include an interference mitigation system (IMS) 110, whereby, as further described, IMS 110 and included components can be configured to determine occurrence of signal interference, identify UEs 140A-n potentially causing/contributing to the interference, and further mitigate the interference. IMS 110 can include a DU signal component 112A configured to control/schedule transmission of downlink signals 125A-n and uplink signals 126A-n at the respective base stations 122A-n. IMS 110 can also include a DU interference component 114A configured to determine occurrence/magnitude of signal interference at the base stations 122A-n across RAN 100.

Each base station 122A-n can include an RU 123A-n, wherein an RU 123A-n located at a base station 122A-n can be configured to transmit signals to (e.g., downlink signals 125A-n), and receive signals from (e.g., uplink signals 126A-n), one or more UEs 140A-n. Signals 125A-n and 126A-n can include data 127A-n (e.g., voice data, messaging data, images, and so on), wherein RUs 123A-n can be further configured to process signals 125A-n and 126A-n and transfer data 127A-n to, or receive data 127A-n from, the DU 105. RU 123A-n can also be configured to control scheduling of uplink signals 126A-n transmitted from UEs 140A-n.

Various communications/signals 165A-n can be generated and transferred between any of DU 105, RUs 123A-n, and/or UEs 140A-n, wherein communications 165A-n can include, instructions, notifications, selections, signal scheduling instruction(s) 133A-n, signal transmission configuration(s), lists, and such, as further described.

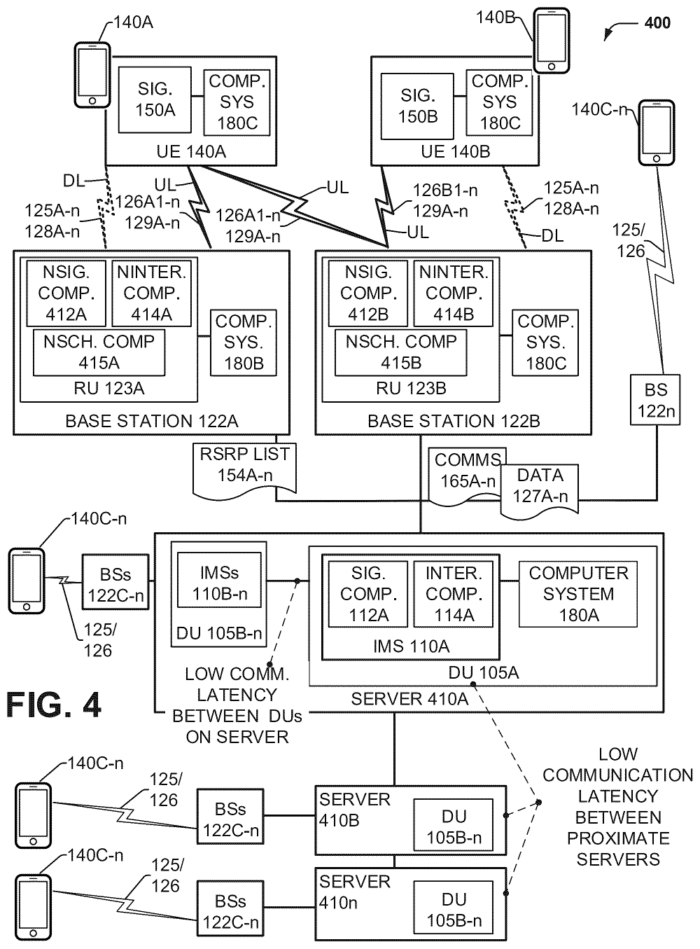

Operating within cells 120A-n are a group of UEs 140A-n, wherein the UEs 140A-n can be statically located or mobile across one or more of the cells 120A-n. A UE 140A-n can be communicating with a respective cell 120A-n (via associated base station 122A-n/RUs 123A-n) via respective uplink signals 126A-n and downlink signals 125A-n, as further described. Downlink signals 125A-n can include reference signals 128A-n. Uplink signals 126A-n can include a sounding reference signal (SRS) 129A-n. UE 140A-n can include a UE signal component 150A-n configured to generate/transmit/receive/process downlink signals 125A-n and uplink signals 126A-n, and further, configured to control scheduling of downlink signals 125A-n and uplink signals 126A-n at UE 140A-n (as shown in FIG. 4).

The following presents a sequence of operations (as identified on FIG. 1) and devices/components involved during respective stages of interference identification and mitigation.

At 1:1, a UE 140A (e.g., first UE) can be configured to determine (e.g., by signal component 150A) which of the base stations 122A-n is to service downlink signals 125A1-n and uplink signals 126A1-n to/from the UE 140A. Service determination can comprise of UE 140A receiving reference signals 128A-n (e.g., in downlink signals 125A-n) respectively transmitted/broadcast from the base stations 122A-n. Each reference signal 128A-n includes a base station identifier, enabling UE 140A to determine which base station 122A-n transmitted the reference signal 128A-n. For example, a first reference signal 128A received at UE 140A is transmitted from first base station 122A, a second reference signal 128B received at UE 140A is transmitted from second base station 122B, an n^{th} reference signal 128n received at the first UE 140A is transmitted from an n^{th} base station 122n.

Signal component 150A can be configured to receive the reference signals 128A-n and further determine an RSRP signal strength 152A-n, aka reference signal received power (RSRP), with which each reference signal 128A-n is received at the UE 140A-n. For example, a first reference signal 128A received at UE 140A is transmitted from first base station 122A and has an RSRP 152A, a second reference signal 128B received at UE 140A is transmitted from second base station 122B and has an RSRP 152B, an n^{th} reference signal 128n received at the first UE 140A is transmitted from an n^{th} base station 122n and has an RSRP 152n.

TABLE 1, below, provides some example RSRP values 152A-n and associated signal qualities, wherein the signal strength ratings and descriptions are arbitrary. RSRP 152A-n is a measure of power of a signal 125A-n being received at a UE 140A-n from a base station 122A-n, the higher the RSRP decibels the greater the data transmission speeds and the greater the reliability of a connection.

TABLE 1
EXAMPLE RSRPs AND SIGNAL STRENGTH/QUALITY.

| RSRP | | |
|---|---|---|
| decibels | Signal strength | Description |
| −60 dBm | Excellent | Strong signal. Data speed is not limited |
| to −80 dBm | | by the radio connection - other factors |
| | | (such as congestion or device throttling) |
| | | can affect performance. Improving the |
| | | signal strength further will not improve |
| | | speed. |
| −80 dBm | Good | Strong signal. Improving the signal |
| to −90 dBm | | strength further will produce only small |
| | | speed improvements. |
| −90 dBm | Fair to poor | Connection likely to be reliable, but |
| to −100 dBm | | slow. Drop-outs are possible. |
| | | Improving the signal strength should |
| | | produce a good improvement in speed. |
| −100 dBm | No signal | Disconnection |
| to −120 dBm | | |

At 1:2, UE signal component 150A can be further configured to generate an RSRP list 154A comprising a list of the base stations 122A-n from which a respective reference signal 128A-n was received at the UE 140A. UE signal component 150A can be further configured to rank the base stations 122A-n in list 154A in order of RSRP/signal strength 152A-n of the respective reference signal 128A-n respectively received from the respective base stations 122A-n. Hence, a base station 122A having the highest RSRP 152A appears highest in the RSRP list 154A, a base station 122n having the lowest signal strength 152n appears lowest in the RSRP list 154A.

UE signal component 150A can be further configured, based on the ranked listing 154A, to determine that base station 122A has the highest signal strength 152A, and based thereon, the signal component 150A can be configured use base station 122A to service signals 125A-n and 126A-n between the UE 140A and the DU 105. In an embodiment, UE 140A can be configured to periodically measure the RSRP signal strength 152A-n of the surrounding/neighboring base stations 122A-n and transfer/switch signaling 125A-n/126A-n to a different base station 122A-n in the event of the RSRP signal strength 152A-n is better at the neighboring base station 122A-n. For example, in the event of signal component 150A subsequently determines RSRP 152C of reference signals 128C received from base station 122C have a higher magnitude of signal strength than reference signals 128A, signal component 150A can engage base station 122C as the base station to serve communications 165A-n between the UE 140A and DU 105.

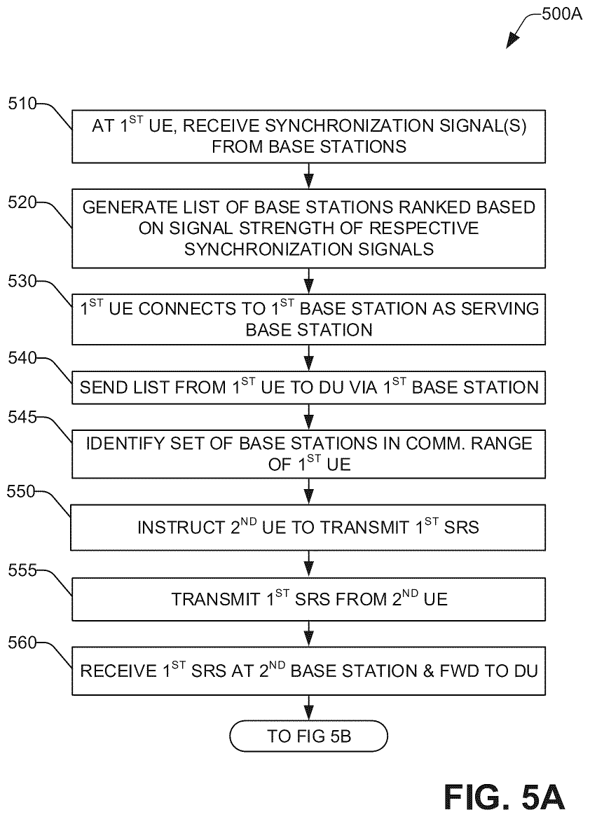

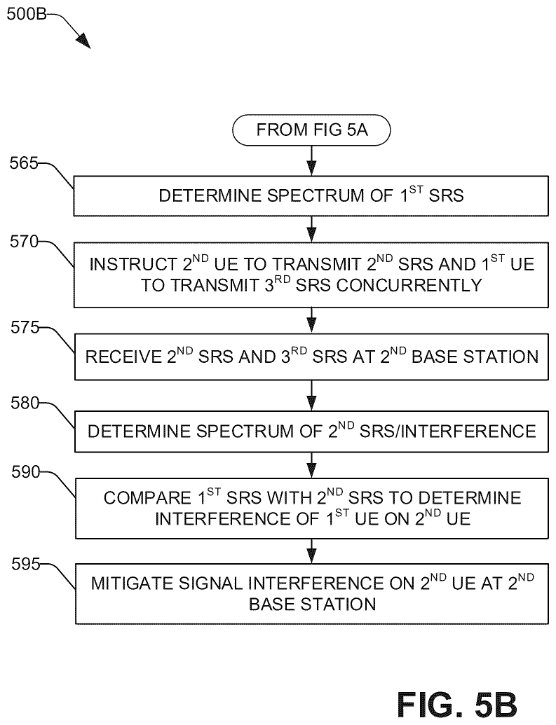

An alternative approach to selection of a base station to utilize as a serving base station can be based on signal pass loss between respective base stations and a UE, as further described in FIG. 5, step 530.

The base stations 122A-n which appear in the RSRP list 154A are those base stations 122A-n that the UE 140A can “see” (receive downlink signals 125A-n from), and further, given the UE 140A-n can see the listed base stations 122A-n, uplink signals 126A-n generated and transmitted by UE 140A can also be received at the respective base station 122A-n. Accordingly, signals 126A generated and transmitted by UE 140A can interfere with other uplink signals/transmissions 126B-n received at a base station 122B (e.g., a second base station) from other UEs 140B-n, even though base station 122B is currently not functioning as a serving base station to process communications 165A-n from UE 140A. As further described, UE signal component 150A can be configured to further transmit the RSRP list 154A (e.g., in a communication 165R) to DU 105, e.g., via base station 122A, with respective signal/code conversion occurring at RU 123A.

The foregoing aspect differs from a conventional approach of the RSRP list 154A is used only by the UE 140A to establish a serving base station (e.g., base station 122A). Per the various embodiments presented herein, the RSRP list 154A-n can be utilized at DU 105 to identify candidate interfering UEs 140A-n, as further explained. In an embodiment, the forgoing can be performed by any of the UEs 140A-n located/operating across cells 120A-n, thereby enabling IMS 110 to determine UEs 140A-n generating uplink signals 126A-n that are potentially interfering with signaling at one or more base stations 122A-n, and further attempt to limit/mitigate interference occurring for uplink signals 126A-n at a base station 122A-n.

At 1:3, scheduled transmission of an SRS from candidate interfering UEs 140A-n can be performed. DU signal component 112, at IMS 110, can be configured to receive and process list 154A, whereby list 154A provides the IMS 110 with a list of all of the base stations 122A-n that are potentially receiving uplink signals 126A from UE 140A, wherein uplink signals 126A may be interfering with uplink signals 126B-n from other UEs 140B-n that are being serviced by other base stations 122B-n, e.g., as previously mentioned, per FIG. 14.

### 4. RESOURCE BLOCK/SUB-BAND SIGNAL QUALITY AND MCS SELECTION BASED ON SRS

At 1:4, in an embodiment, DU signal component 112 can be configured to generate a schedule 133A-n defining when an uplink SRS 129A-n is to be transmitted by each of the candidate interfering UEs 140A-n (e.g., UE 140A) as well as a UE 140A-n (e.g., UE 140B) being served by a respective base station 122A-n. In an embodiment, IMS 110 can obtain from a UE 140B a first uplink SRS 129B1, wherein the uplink SRS 129B1 can be transmitted from UE 140B when no SRS 129A1-n is being transmitted by the potentially interfering UE 140A.

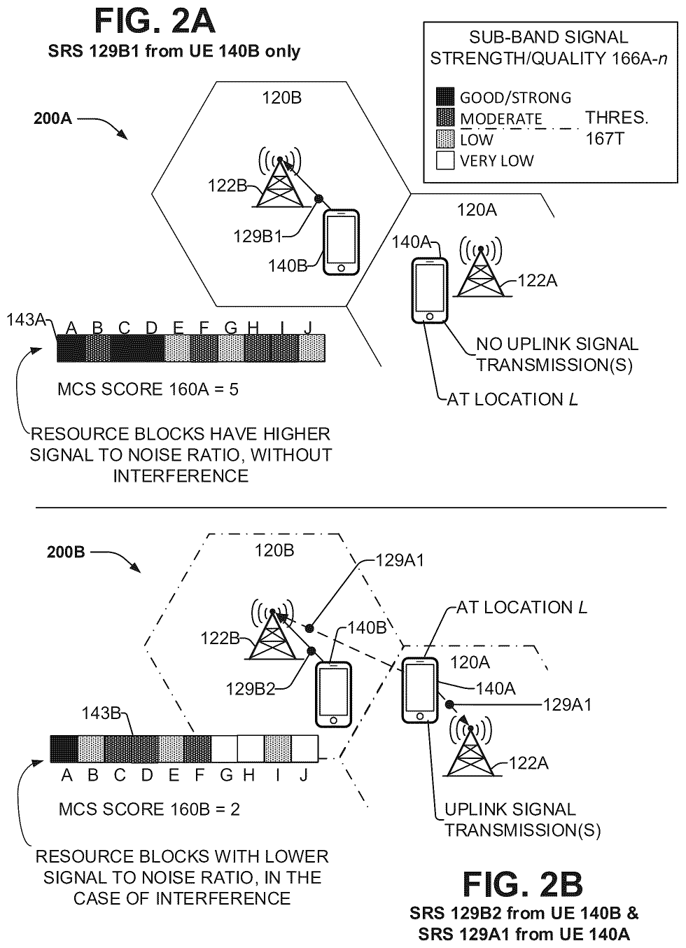

Turning to FIGS. 2A and 2B, schematics 200A and 200B present signal quality determination being performed with (a) a scheduled SRS transmitted from a single UE (FIG. 2A) in conjunction with (b) a scheduled SRS from the single UE transmitted concurrently with uplink signals/SRSs transmitted by other UEs (FIG. 2B), in accordance with one or more embodiments.

FIGS. 2A and 2B illustrate SRSs 129A-n being received from a UE 140B (e.g., second UE), where base station 122B is functioning as a serving base station UE 140B. Each of the SRSs 129A-n include a frequency spectrum 143A-n comprising sub-bands A-J (aka resource blocks). In an embodiment, one or more of the sub-bands A-J can form a portion of a respective frequency spectrum 143A-n. In the example presented in FIGS. 2A and 2B, an SRS 129A-n comprises ten frequency sub-bands A-J, however the sequence is arbitrary and a sequence of any number of sub-bands/frequency ranges can be utilized.

DU interference component 114 can be configured to (a) receive signal strength data 127A-n regarding SRSs 129A-n, (b) identify/extract the frequency spectrum 143A-n A-J, (c) determine whether SRSs 129A-n indicate interference is being encountered at base station 122B, and (d) further mitigate an effect(s) of the interference.

Per FIG. 2A, a first SRS 129B1 was scheduled (e.g., by DU signal component 112) for transmission when no other uplink signals 126A-n are being transmitted by other UEs 140A and 140C-n. SRS 129B1 can function as a base/foundation signal/frequency spectrum (e.g., best quality signal) against which subsequent SRS's 129B2-n received from UE 140B/at base station 122B can be compared, where SRS's 129B2-n are generated as a function of potential signal interference from signals transmitted by UE 140A (e.g., per FIG. 2B).

As shown, DU interference component 114 can be further configured to determine a signal strength/quality 166A-n for the respective sub-bands A-J. In the examples presented in FIGS. 2A and 2B, sub-band signal strength/quality 166A-n are represented based on four qualifiers: good (depicted with a totally black square), moderate (a dark grey square), low (a light grey square), and very low (a white/empty square). Hence, where SRS 129B1 received from UE 140B is transmitted with no interference from other UEs 140A and 140C-n, DU interference component 114 determines the quality of the sub-bands in SRS 129B1 to be: sub-band A=good, sub-band B=moderate, sub-band C=good, sub-band D=good, sub-band E=low, sub-band F=moderate, sub-band G=low, sub-band H=moderate, sub-band I=moderate, and sub-band J is moderate. Further, DU interference component 114 determines an MCS score 160B1 of 5 for SRS 129B1 (as further described below). In an embodiment, a threshold sub-band signal strength 167T can be set (e.g., moderate and good are acceptable, low and very low are not acceptable), and upon determining interference is occurring, subsequent uplink signals 126A-n are transmitted in accordance with the threshold 167T, e.g., UE 140B is only to send data on frequency spectrum sub-bands 143A-n A-J having a signal quality of equal to, or greater than, threshold 167T (as set via HMI 186).

Per FIG. 2B, subsequent to transmission of first SRS 129B1, UE 140B transmits a second SRS 129B2 (e.g., per schedule 133A generated by IMS 110), however, unlike transmission of first SRS 129B1 where no other UEs 140A and 140C-n were scheduled to be transmitting uplink signals 126A-n, during transmission of SRS 129B2, UE 140A is also scheduled to transmit uplink signals 126A-n such that uplink signal 126A1 may be causing interference with the second SRS 129B2 received at base station 122B. As shown in FIG. 2B, DU interference component 114 determines frequency spectrum 143B of SRS 129B2 has sub-band signal quality 166A-n of sub-band A has good signal quality; sub-bands C, D, and F have moderate signal quality; sub-bands B, E, and I have low signal quality; and sub-bands G, H, and J have very low signal quality. DU interference component 114 can be further configured to review SRS 129B2 and assigns an MCS score 160B2 of 2 (as further described below).

Given the different sub-band assessments and MCS scores of SRS 129B1 and SRS 129B2, it is evident that signal strength/quality of uplink signals 126B1-n being transmitted by UE 140B are prone to being affected by interference at base station 122B derived from other uplink signals 126A generated by UE 140A (and possibly other uplink signals 126C-n from UEs 140C-n), even though base station 122B is not operating as the serving base station for UE 140A (or UEs 140C-n).

From the foregoing, it is possible to determine the domain of interference of one or more candidate UEs 140A and 140C-n on base station 122B. By scheduling an uplink signal 126A1 from UE 140A to coincide with an uplink signal 126B2 from UE 140B, it is possible to determine the interference effect of signals 126A1-n from UE 140A on uplink signals 126B1-n from UE 140B at base station 122B. For each UE 140A and 140C-n, SRS 129A-n can be scheduled such that a single candidate UE 140A/140C-n is transmitting during the signaling presented in FIG. 2B.

Per the foregoing, DU interference component 114B has determined UE 140A is potentially interfering with UE 140B, with uplink signals 126A1-n from UE 140A potentially interfering with uplink signals 126B1-n received at base station 122B from UE 140B.

It is to be appreciated that while FIGS. 2A and 2B depict SRS 129A-n at UEs 140A and 140B, any number of the UEs 140A and 140C-n can be processed per the foregoing. If there are four UEs 140A, 140C, 140D, and 140n potentially interfering with signaling by UE 140B, the foregoing can be implemented for each of the UEs 140A and 140C-n, e.g., SRS's 129A1-n, 129C1-n, 129n-n, in combination with SRS' 129B1-n.

### MCS Score & Schema

IMS 110 (e.g., in conjunction with node signal component 412B at base station 122B, per FIG. 4) can be further configured to generate a modulation and coding scheme (MCS) score 160A-n for SRSs 129A-n, whereby the MCS score 160A-n can be a measure of the signal quality/amount of data 127A-n that can be conveyed by uplink data signals 126A-n. The MCS score 160A-n can function as an indicator regarding which MCS 162A-n can be implemented at a UE 140A-n, wherein a respective MCS score 160A-n can be configured to correspond to a respective MCS 162A-n. As previously mentioned, a variety of modulation and coding schemes 162A-n are available to be implemented (e.g., by DU signal component 112 in conjunction with DU interference component 114), for example, 256 QAM, 64 QAM, 16 QAM, QPSK, etc.

For example, MCS score 160A-n can have a value ranging from 0 to 5, where 5 indicates SRS 129A-n has a high level of quality/low level of interference, and 0 indicates SRS 129A-n has a low level of quality/high level of interference. A greater volume of usable data 127A-n can be conveyed where uplink signals have an MCS score 160A-n of 5 than can be conveyed in uplink signals having an MCS score 160A-n of 0, 1, 2, etc. The MCS score 160A-n having a range of 0 to 5 is an arbitrary scheme and any range can be utilized.

In an example use case of the various embodiments presented herein, an MCS score 160A-n of 5 indicates signal quality is excellent and an MCS 162A-n having a high data rate can be utilized, e.g., 256 QAM. An MCS score 160A-n of 3 enables 64 QAM to be utilized, a score of 1 enables QPSK, while a score of 0 means that interference is substantial to render signaling feasibly unworkable.

With an MCS score 160A-n of 5 determined for an SRS 129A-n, subsequent uplink signals 126A-n generated/transmitted by the second UE 140B can be configured to comprise a high level of data 127A-n as uplink signals 126A-n from the second UE 140B are undergoing a low level/minimal interference from uplink signals 126A-n generated by other UEs 140A and 140C-n. Accordingly, MCS 162A=256 QAM can be implemented by DU interference component 114.

With an MCS score 160A-n of 2 determined for an SRS 129A-n, SRS 129A-n is either poor quality or undergoing interference from other uplink signals generated by other UEs 140A and 140C-n. To ensure a desired target BLER/integrity of data 127A-n, less data 127A-n should be transmitted in subsequent uplink signals 126A-n having an MCS score 160A-n of 2. Accordingly, MCS 162B=16 QAM can be implemented by DU interference component 114.

In an embodiment, the PUSCH DMRS of the candidate interfering UEs 140A-n can be processed, e.g., at DU 105 or at the potentially affected base station 122A-n to determine interference of frequency spectrum/resource blocks 143A-n allocated to the PUSCH of the affected base station 122A-n.

### 5. INTERFERENCE MITIGATION

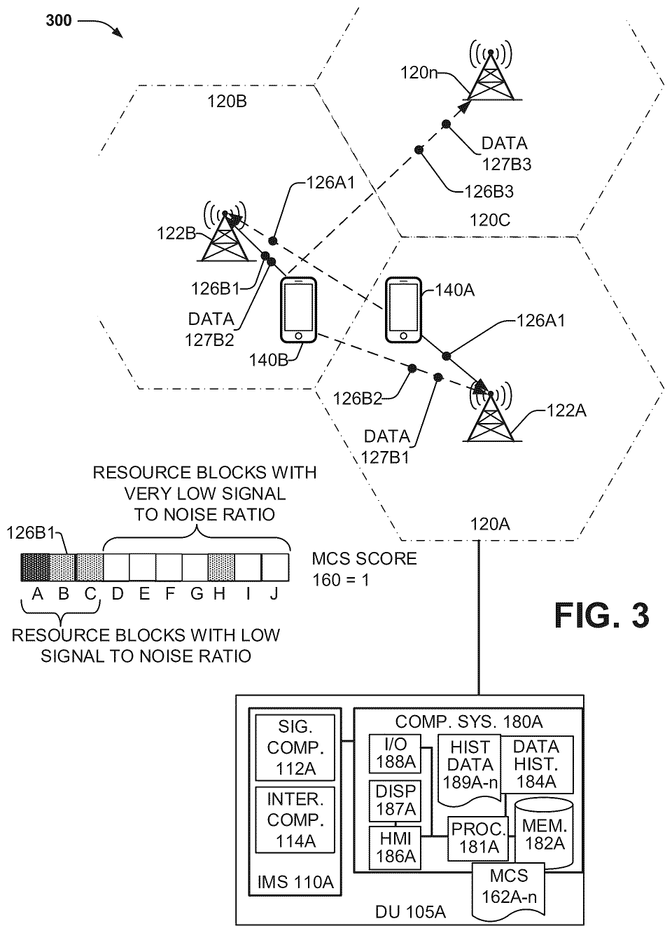

Returning to FIG. 1, at 1:5, with DU interference component 114 having determined a potential interference of uplink signals 126A-n, uplink signals to the base station 122B can be controlled. In an embodiment, DU signal component 112 can generate and forward an instruction (e.g., in communication 165A-n/schedule 133A-n) instructing a UE 140A-n to operate to avoid the potential interfering signals. As further described, instruction 165A-n can be configured to, in a non-limiting list:
(a) instruct a UE 140B to only transmit data 127A-n in specific frequency spectrum 143 sub-bands A-J (e.g., in a defined base frequency spectrum 143X and sub-bands A-J, as generated by DU interference component 114A),
(b) instruct UE 140B to transmit data 127A-n in accordance with a specific MCS 162A-n (e.g., MCS 162X defined/generated by DU interference component 114A),
(c) utilize a beamforming technique to ensure signals are transmitted towards the base station 122A-n that is serving the respective UE 140A-n, e.g., UE 140B beamforms uplink signals 126A-n directed towards the base station 122B, UE 140A beamforms uplink signals 126A-n directed towards the based station 122A,
(d) uplink signals 126A-n from a UE 140A-n are captured at all of the base stations 122A-n receiving the uplink signals 126A-n (e.g., within transmission range, can see the respective UE 140A-n) and are combined at DU 105 in cooperative reception. In an example scenario, while base station 122B is functioning as the signal servicing base station for uplink signals 126A-n transmitted by UE 140B, the corresponding uplink signals 126A-n transmitted by UE 140B and received at the other base stations 122A and 122C-n are forwarded by the base stations 122A and 122C-n to IMS 110, whereupon the DU signal component 112 can be further configured to combine the uplink signals 126A-n received from the various base stations 122A-n to enable combination/supplementation of data 127A-n that may be in the uplink signals 126A-n generated and broadcast from UE 140B (e.g., per FIG. 3).

### Transmit on Defined Sub-Bands & MCS

In an embodiment, DU interference component 114 can be further configured to generate an instruction 165H defining which sub-bands 143A-n are to be utilized for transmission of data 127A-n between UE 140B and base station 122B. UE signal component 150B, at UE 140B, can be configured to implement instruction 165H. In an embodiment, instruction 165H can comprise the sub-bands 143A-n having moderate or good level of signal quality 166A-n. Hence, per FIG. 2B, DU interference component 114 can select frequency spectrum 143A-n sub-bands A, C, D, and F, for use by UE 140B for uplink signals 126A-n, such that any signal loss, if any, is at an acceptable level, and data 127A-n can be transmitted at these sub-bands/levels. Accordingly, to avoid loss of data 127A-n that may occur with the low and very low signal qualities 166A-n, DU interference component 114 can be configured to instruct (e.g., in instruction 165H) UE 140B not to transmit data 127A-n to base station 122B on frequency spectrum 143A-n sub-bands B, E, G, H, I, and J for sending data 127A-n, as these sub-bands are either of insufficient quality and/or undergoing interference from UE 140A (or any other interfering UE 140C-n).

Similarly, as the MSC score 160A-n decreases from level 5 to 0, the quality of the selected MSC 162A-n to use can also be controlled, such that with an MCS score 160A-n of 5, DU signal component 112 can instruct signal component 150B at UE 140B to use a high data schema (e.g., 256 QAM), reducing to QPSK at level 1, and potentially, temporarily terminate transmission from UE 140B when the MCS score 160A-n is 0.

### 6. PARTLY INDEPENDENT SCHEDULING

In an embodiment, RUs 123A-n (e.g., node signal components 412A-n) located at each of the base stations 122A-n can be configured to operate independently regarding scheduling uplink signals 126A-n from respective UEs 140A-n. This approach can lead to a reduction in scheduling effort across the RAN 100.
1) the base stations 122A-n can be configured to share a schedule 133A-n (e.g., as defined by DU signal components 112A-n, node signal components 412A-n) detailing the next scheduled slots to be used by an interfering UE 140A. In an aspect, such an approach can reduce the amount of information exchanged across the RAN 100, such that the base stations 122B-n could be configured to limit the scope of sharing, and share the schedule 133A-n of the designated interfering UE 140A with only the identified (per SRS 129A-n and frequency spectrums 143A-n), potentially interfered, base stations 122B-n. In another aspect, the power of the interference can be updated for a given scheduled slot in schedule 133A-n taking into account all the transmit power control commands (TPC) that were issued, and the other parameters in the power control loop (power headroom considerations, and PUCCH-related configurations). Hence, base station 122A serving interfering UE 140A can be configured to provide an estimate of the power difference between the previous SRS 129A and the current slot's transmissions in schedule 133A-n.
2) base stations 122B-n can be configured to update the MCS 162A-n of the interfered UEs 140B-n, in order to achieve a desired target BLER. To achieve the desired target BLER, the degradation in SNR would be considered due to the interfering uplink signal 126A and the direction of the interfering uplink signal 126A (e.g., with correlation over RX antennas).

### 7. SCHEDULE PREVENTION

In a scenario where UE 140B is undergoing significant degradation in quality of uplink signals 126B1-n owing to interference caused by uplink signals 126A1-n from UE 140A, scheduled signaling from the interfering UE 140A can be prevented, in schedule 133A-n. For example, the affected base station 122B can generate an instruction 165B instructing base station 122A serving the interfering UE 140A to prevent scheduling of uplink signals 126A1-n from UE 140A. Node schedule component 415A can be configured to instruct UE 140A (e.g., signal component 150A) to prevent scheduling of uplink signals 126A1-n. In another example, DU signal component 112 can generate a schedule 133A-n/instruction 165S instructing base station 122A not to schedule UE 140A.

In another scenario, two or more base stations 122A-n can be configured to operate in combination not to schedule uplink signals 126A-n/or sets of sub-bands A-J in frequency spectrum 143A-n as a consequence of interference:
a) the two or more base stations 122A-n can be configured to implement this embodiment when low SNR in frequency spectrum 143A-n sub-bands A-J is being experienced, e.g., at UE 140B.
b) the two or more base stations 122A-n (e.g., between node signal components 412A and 412B) can share priority of scheduling of signals 126A-n (e.g., with a value of 0 to 100). For example, base station 122A can be assigned a priority value 134A of 40, base station 122B can be assigned a priority value 134B of 75, such that base station 122B has priority over base station 122A when a scheduling conflict arises. Base station 122C is assigned a priority value 134A-n of 25, such that both base stations 122A and 122B have priority over 122C. Priority values 134A-n can be assigned priority via an HMI (e.g., HMI 186/screen 187) interacting with DU signal component 112.
c) in the event of base stations 122A and 122B have both been assigned the same priority value (e.g., base station 122A and base station 122B have both been assigned a priority value 134A-n of 75), a fairness rule can be applied such that over time base stations 122A and 122B have an equal number of prioritized scheduling versus did not schedule signal transmission. A signal component (e.g., node signal components 412A-n or DU signal components 112A-n) can be configured to count a number of times base station 122A and 122B respectively took priority in/avoided scheduling the UEs 140A-n which are respectively being served by the respective base station 122A-n. The respective signal component can be configured to ensure the fairness rule of equal scheduling is achieved where the same priority values exist.
d) in the event of base station 122A cancels an allocated/scheduled transmission of uplink signals 126A-n at UE 140A, base station 122A can notify (e.g., in communication 165N) the cancellation to the impacted, neighboring base stations 122B-n, enabling base stations 122B-n to disregard uplink signals 126A. This approach lessens an amount of information exchange/signal processing to address an interference/scheduling conflict.

Schedule prevention may result in an increase in latency across the RAN 100 as an additional step of scheduling and additional exchange of information is required, however the amount of data required to prioritize and/or cancel a schedule is small.

### 8. BEAMFORMING

In another embodiment, DU signal component 112 can further generate and transmit an instruction 165I to both base stations 122A-n and also UEs 140A-n instructing the respective systems to implement beamforming and adjust precoding to facilitate directional signaling (spatial separation) in the direction of a respective base station 122A-n assigned to function as a serving base station for the respective UE 140A-n. Accordingly, uplink signals 126A1-n broadcast by UE 140A are transmitted in the direction of base station 122A and uplink signals 126B1-n broadcast by UE 140B are transmitted in the direction of base station 122B, thereby mitigating potential interference between uplink signals 126A1-n and uplink signals 126B1-n.

### 9. COOPERATIVE RECEPTION

FIG. 3, system 300, presents a system where uplink signals received at a group of base stations are combined to compile data, in accordance with an embodiment.

As shown, a first UE 140A is being serviced by a first base station 122A with first uplink signals 126A1-n being received and processed at first base station 122A (e.g., base station 122A is the serving station for UE 140A). A second UE 140B is being serviced by a second base station 122B with second uplink signals 126B1-n being received and processed at second base station 122B (e.g., base station 122B is the serving station for UE 140B). As previously mentioned, first uplink signals 126A1-n generated by first UE 140A can give rise to interference with second uplink signals 126B1-n generated by second UE 140B being received at second base station 122B.

Per the example presented in FIG. 3, uplink signals 126B are experiencing a high level of interference, whereby resource blocks/sub-bands A-C collectively have a low signal to noise ratio (SNR), while sub-bands D-J collectively have a very low SNR. In an embodiment, in the event that interference of first uplink signals 126A1-n with second uplink signals 126B1-n being received at base station 122B cannot be addressed by utilizing either frequency spectrum sub-band selection 143A-n A-J or MCS 162A-n selection, second uplink signals 126B1-n received at any of the base stations 122A-n (as identified in the RSRP list 154A-n) can be captured by the respective RU 123A-n, processed, and data 127A-n in the second uplink signals 126B1-n received at all of the base stations 122A-n in the RSRP list 154A-n can be forwarded to DU signal component 112A.

As shown in FIG. 3, a first portion 126B1 of uplink signals 126B1-n are received at base station 122B, a second portion 126B2 of uplink signals 126B1-n are received at base station 122A, and a third portion 126B3 of uplink signals 126B1-n are received at base station 122n. First portion 126B1, second portion 126B2, and third portion 126B3 can be forwarded to DU 105, where the DU signal component 112A can be configured to combine the portions 126B1/126B2/126B3 of uplink signals 126B1-n, thereby combining whatever data 127B1/127B2/127B3 is available in the first portion 126B1, second portion 126B2, and third portion 126B3.

Hence, in the event of interference at base station 122B is causing loss of data 127B1-n in portion 126B1 of uplink signals 126B1-n, the data 127B1-n lost due to interference at base station 122B may be available/extracted from the uplink signals 126B1-n received at the base stations 122A and 122C-n.

In an embodiment, DU 105 can utilize NR's multi-TRP feature to configure multiple cells to receive and process uplink signals 126A-n of an affected UE 140A-n/spectrum. In an embodiment, the following sequence of events for cooperative reception can be employed:
1) in the case that any base station 122A-n fails to decode an uplink signal 126A-n, in a bandwidth that contains scheduled interference, the failing base station, e.g., base station 122B (e.g., node signal component 412B) can be configured to generate and transmit a request communication 165R to the other base stations 122A and 122C-n that are affected by/contain the interference.
2) the decoded interfering signals 126A-n received at the other base stations 122A and 122C-n are sent from the other base stations 122A-n to the failed base station 122B.
3) the failed uplink transmission 126B1-n can re-undergo decoding after removal of the estimated interference using a channel estimation of the interfering UE 140A and UE 140C-n in conjunction with the decoded bits provided by the other base stations 122A and 122C-n.
4) with a BLER setting of 10% (for example), steps 1-4 can reduce a need for signal retransmissions, and probably increase throughput by almost 10% when an interfering signal 126A-n is as low as −3.

As further shown in FIG. 3, DU 105A includes a memory 182A configured to store the respective computer executable components (e.g., DU signal component 112A, DU interference component 114A, IMS 110A, data historian 184A-n, and such), at DU 105A, and comparable components located across RAN 100/400 (per FIGS. 1 and 4), and further, a respective processor 181A-n configured to execute the computer executable components stored in the memory 182A-n. Memory 182A-n can be further configured to store any of data 127A-n, schedules 133A-n, schedule priority 134A-n, MCS score 160A-n, MCS 162A-n, communications 165A-n and content of communications 165A-n, sub-band signal quality 166A-n, sub-band signal quality threshold 167A-n, RSRP list 154A-n, frequency sub-bands 143A-n A-J, historical data 189A-n, and such (as further described herein).

Data historian 184A-n can be configured to generate/update historical data 189A-n with any information regarding any of current/prior/future data 127A-n, schedules 133A-n, schedule priority 134A-n, communications 165A-n and content of communications 165A-n, MCS score 160A-n, MCS 162A-n, RSRP list 154A-n, frequency sub-bands 143A-n A-J, sub-band signal quality 166A-n, sub-band signal quality threshold 167A-n, and such.

Respective computer systems 180A-n can further include a human machine interface (HMI) 186A-n (e.g., a display, a graphical-user interface (GUI)) which can be configured to present various information including data 127A-n, schedules 133A-n, schedule priority 134A-n, communications 165A-n and content of communications 165A-n, MCS score 160A-n, MCS 162A-n, RSRP list 154A-n, frequency sub-bands 143A-n A-J, sub-band signal quality 166A-n, sub-band signal quality threshold 167A-n, and such, per the various embodiments presented herein. HMI 186A-n can include an interactive display/screen 187A-n to present the various information, e.g., data 127A-n, schedules 133A-n, schedule priority 134A-n, communications 165A-n and content of communications 165A-n, MCS score 160A-n, MCS 162A-n, RSRP list 154A-n, frequency sub-bands 143A-n A-J, and further enable addition/updating of schedules, priorities 134A-n, MCS 162A-n, etc.

Computer systems 180A-n can further include an I/O component 188A-n to receive and/or transmit respectively data 127A-n, schedules 133A-n, schedule priority 134A-n, communications 165A-n and content of communications 165A-n, MCS 162A-n, MCS score 160A-n, RSRP list 154A-n, frequency sub-bands 143A-n A-J, and further enable addition/updating of schedules, priorities 134A-n, MCS 162A-n, etc.

### 10. INTERFERENCE DETERMINATION BASED ON UE LOCATION

In an embodiment, rather than utilizing reference signals 128A-n to determine the presence of UE 140A (and UEs 140B-n) within a cell 120A-n, the location L of UE 140A (per FIGS. 2A and 2B) can be utilized, wherein the location of UE 140A can be reported by UE 140A to DU 105 using a location L defined by UE 140A (e.g., based on triangulation of UE 140A with reference to base stations 122A-n). For example, a UE 140A located at an edge of a cell 120A-n is more likely to generate uplink signals 126A-n interfering with neighboring base stations 122A-n. For example, per FIG. 1, with UE 140A located near the edge of cell 120A (with signaling serviced by base station 122A), it is probable that uplink signals 126A-n generated by UE 140A can cause interference with uplink signals 126A-n being received at base stations 122B and 122C, with a lower probability that uplink signals 126A-n generated by UE 140A can cause interference with uplink signals 126A-n being received at base station 122n (owing to the greater distance of base station 122n from UE 140A compared to the respective distance of base stations 122B and 122C from UE 140A).

### 11. INTERFERENCE MITIGATION ACROSS A RAN

FIG. 4, schematic 400, illustrates various components and systems to determine and mitigate interference in a RAN comprising a collection of data servers, associated DUs, base stations, etc., in accordance with an embodiment.

As shown, DU 105A can be communicatively coupled to/located in a first data server 410A, wherein the first data server 410A can be further communicatively coupled to one or more other data servers 410B-n. It is to be appreciated that while the foregoing (e.g., per FIGS. 1-3) describes a single DU 105A determining one or more interfering UEs 140A-n connected to base stations 122A-n connected to DU 105A, the embodiments can be extended across DUs 105A-n operating on a collection of data servers 410A-n, and further, the base stations 122A-n and UEs 140A-n connected to those DUs 105A-n.

Accordingly, interference analysis and mitigation can be performed across a geographic region equating to the cells 120A-n served by any of the base stations 122A-n presented in FIG. 4, as connected to a group of DUs 105A-n and further connected to data servers 410A-n. A single IMS 110 at a DU 105A can perform interference analysis and mitigation for the various data servers 410A-n, DUs 105A-n, base stations 122A-n, and UEs 140A-n. Alternatively, multiple IMSs 110A-n can be operating in conjunction, e.g., based on the implementation reference signals 128A-n, RSRP lists 154A-n, and SRS 129A-n across RAN 100/400.

In an aspect, the only limit on the scope of implementation of the various embodiments presented herein is signal/data transmission latency (e.g., of RSRP lists 154A-n, communications 165A-n, data 127A-n, schedules 133A-n, etc.) between the respective systems illustrated in FIG. 4. For example, DUs 105A-n are located on a single data server 410A, and/or DUs 105A-n are located on a set of data servers 410A, being sufficiently proximate to each other that exchange of signaling data between the DUs 105A-n, data servers 410A-n, and an IMS 110A performing interference analysis, is of sufficiently low latency to enable timely determination/implementation frequency spectrum 143A-n sub-band frequency A-J selection, MCS 162A-n selection, UE 140A-n, scheduling 133A-n, etc., at the IMS 110A, the base stations 122A-n, and/or the UEs 140A-n.

DUs 105A-n can respectively include an IMS 110A-n (which further include a DU signal component 122A-n and a DU interference component 114A-n), whereby IMS 110A-n, DU signal components 112A-n, and DU interference components 114A-n can operate in a manner comparable to a DU signal component 112/112A and DU interference components 114A-n previously described in FIGS. 1-3.

In an aspect, scheduling and mitigation can be performed at any part of the network system. Hence, while the foregoing describes signaling being controlled by the DU signal component 112 and DU interference component 114 located in DU 105, signaling can be controlled at the base station level, e.g., by a node signal component 412A-n, interference assessment by node interference component 414A-n, and node schedule component 415A-n, e.g., per schedule 133A-n, frequency sub-bands 143A-n A-J, MCS 162A-n. A node signal component 412B and a node schedule component 415B can be configured to determine interference between UE 140B and UE 140A, and based thereon, can adjust scheduling of UEs 140A and 140B, as previously described with regard to prioritizing scheduling, denying scheduling, and such.

Per the various embodiments presented herein, the RSRP list 154A-n can be provided to any of the node signal components 412A-n, interference components 414A-n, with each base station 122A-n having knowledge of candidate UEs 140A-n that are potentially interfering with uplink signals 126A-n being received at the respective base station 122A-n. Node schedule components 415A-n and DU interference components 114A-n respectively located at the respective base station 122A-n can be configured to prioritize uplink signals 126A-n being received from UEs 140A-n served by the respective base station 122A-n, while assisting to reduce potential interference being experienced at other base stations 122A-n as a result of ubiquitous broadcasting of uplink signals 126A-n by the UE 140A-n being served by the base station 122A-n.

As shown, DUs 105A-n, base stations 122A-n, UE's 140A-n, data servers 410A-n can include a computer system 180A-n, wherein computer system 180A-n is comparable to computer system 180A located in DU 105A, per FIG. 3, and further expanded per systems and components presented in FIG. 4, such that memory 182A-n can be further configured to store the respective computer executable components (e.g., node signal component 412A-n, node interference component 414A-n, node schedule component 415A-n, UE signal component 450, and such).

FIGS. 5A and 5B, via flowcharts 500A and 500B, present a computer-implemented method for determining potential for signals generated by a first UE interfering with signals generated by at least one other UE, in accordance with an embodiment.

At 510, a first UE (e.g., UE 140A) can be configured to receive (e.g., via first UE signal component 150A) a set of reference signals (e.g., reference signals 128A-n), wherein respective reference signals in the set of reference signals are respectively transmitted from a group of base stations (e.g., base stations 122A-n). In an embodiment, receipt of a first reference signal (e.g., reference signal 128A) from a first base station (e.g., base station 122A) indicates that the UE is within transmission range of the first base station, and further, the first base station is within transmission range of the UE. Similarly, receipt of a second reference signal (e.g., reference signal 128B) from a second base station (e.g., base station 122B) at the first UE indicates that the first UE is within transmission range of the second base station, and further, the second base station is within transmission range of the UE. Accordingly, in the event of the UE is being served by the first base station, but the second base station can also receive any signals (e.g., uplink transmissions) generated by the UE, the signals can interfere with uplink signals being generated by other UEs being serviced by the second cell tower.

At 520, the first UE signal component at the first UE can be configured to generate a list (e.g., RSRP list 154A-n) representing the base stations from which the reference signals were received. In an embodiment, the first UE signal component can be further configured to rank the list according to a respective signal strength of the respective reference signals respectively received from the respective base stations.

At 530, in an embodiment, the first UE signal component can be further configured to implement/connect with a first base station (e.g., base station 122A) having the highest signal strength as the serving base station for communications between the first UE, the first base station, and the radio network (e.g., RAN 100). In another embodiment, the first UE signal component can be further configured to select the first base station to implement as the serving base station as a function of signal power loss. For example, base station x is transmitting a reference signal x with a signal strength of 100 dBms, however, reference signal x is received at the first UE with a signal strength of 50 dBms. Base station y is transmitting a reference signal y with a signal strength of 55 dBms, however, reference signal y is received at the first UE with a signal strength of 47 dBms. Hence, while signal x is being received at the first UE with a signal strength of 50 dBms, the signal pass loss between base station x and the first UE is 50 dBms. Alternatively, while signal y is being received at the first UE with a signal strength of 47 dBms (less than signal x), the signal pass loss between base station y and the first UE is only 8 dBms. Accordingly, the first UE can be configured to select base station y as the serving/first base station as less signal pass loss (only 8 dBms) is being encountered compared with the signal pass loss (e.g., 50 dBms) between the first UE and base station x.

At 540, the first UE signal component at the first UE can be configured to transmit the list to a DU (e.g., DU 105) via the serving/first base station. In an embodiment, the DU can be communicatively coupled to/controlling operation of/signaling at the respective base stations across the RAN.

At 545, a DU signal component (e.g., DU signal component 112) at the DU can be configured to review the list and determine the base stations that are within uplink signal (e.g., uplinks signals 126A-n) range of the first UE.

At 550, the DU signal component can be further configured to instruct (e.g., in first communication 165X) a second UE (e.g., UE 140B) being served by a second base station (e.g., base station 122B), to generate a first SRS (e.g., SRS 129A). The first instruction can be passed to the second UE via the second/serving base station. The first instruction can further include a requirement that no other UEs in communication range of the second base station (e.g., UE 140A) transmit during transmission of the first SRS.

At 555, the first SRS can be transmitted from the second UE in accordance with the first instruction. In an embodiment, a first signal component (e.g., signal component 150B) at the second UE can be configured to schedule and transmit the first SRS.

At 560, the first SRS can be received and processed (e.g., by node signal component 412B at base station 122B) at the second base station, and further forwarded to the DU via the second base station.

At 565, an interference component (e.g., DU interference component 114) at the DU can be configured to analyze the frequency spectrum (e.g., frequency spectrum 143B1 and sub-bands A-J) of the first SRS.

At 570, the DU signal component can be further configured to instruct (e.g., in second communication 165Y) the second UE (e.g., UE 140B) to transmit a second SRS (e.g., SRS 129B) and also schedule the first UE (e.g. UE 140A) to transmit a third SRS (e.g., SRS 129C) at the same time as the second SRS is being transmitted.

At 575, the second SRS and third SRS can be received and processed (e.g., by node signal component 412B at base station 122B) at the second base station, and further transmitted to the DU via the second base station.

At 580, the interference component (e.g., DU interference component 114) at the DU can be configured to analyze the frequency spectrum (e.g., frequency spectrum 143B2 and sub-bands A-J) of the second SRS.

At 590, the interference component can be further configured to determine difference in the frequency spectrum of the first SRS and the frequency spectrum of the second SRS. As previously mentioned, where the third SRS is interfering with the second SRS, the frequency spectrum of the second SRS will be different to the first SRS.

At 595, based on the analysis/determined difference in the frequency spectrum of the first SRS and the frequency spectrum of the second SRS, it is possible to determine the interference effect of first uplink signals generated by the first UE on second uplink signals generated by the second UE received at the second base station. Further, based on the determined interference (e.g., magnitude, sub-bands affected, etc.) it is possible to control/schedule uplink signals respectively generated by the first UE and the second UE to mitigate interference of the second UE by the first UE.

While FIG. 5 illustrates an operating scenario where the DU is configured to control SRS transmission by a first UE (served by a first base station) and a second UE (served by a second base station) such that the timing SRS transmissions by the first UE and the second UE are scheduled to occur at the same time, or substantially at the same time, in another embodiment, transmission of SRS signals from the first UE can be scheduled independently to transmission of SRS signals from the second UE. Scheduling of the respective SRS signals can be defined to ensure that the SRS signals are scheduled for transmission with sufficient periodicity to enable any degradation of uplink signals transmitted by the second UE by transmissions from the first UE to be readily identified. For example, first UE may be statically located while the second UE may be in a vehicle in motion.

Hence, periodicity of SRS transmission by the first UE can remain constant (while the first UE is statically located) while periodicity of SRS transmission from the second UE can be altered (e.g., by the DU). Accordingly, quality and SINR of SRS transmissions from the second UE can be adjusted to ensure detection of SINR of SRS signals/uplink signals dropping below a threshold, wherein the SINR can result from uplink transmissions from the from the first UE. For example, a first series of SRSs are transmitted by the first UE, where the first UE is statically located. A second series of SRSs are transmitted by the second UE, wherein the first series of SRSs are scheduled for transmission independently to the second series of SRSs. The first series of SRSs can be transmitted with a schedule of 100 ms. The second series of SRSs are transmitted with a shorter periodicity, e.g., 60 ms, to enable a frequent analysis of the received second SRS signals to detect any deleterious change in SINR at the second UE as a result of motion of the second UE causing the signal quality, etc., of second series of SRSs to be affected by SRSs/uplink signals from the first UE.

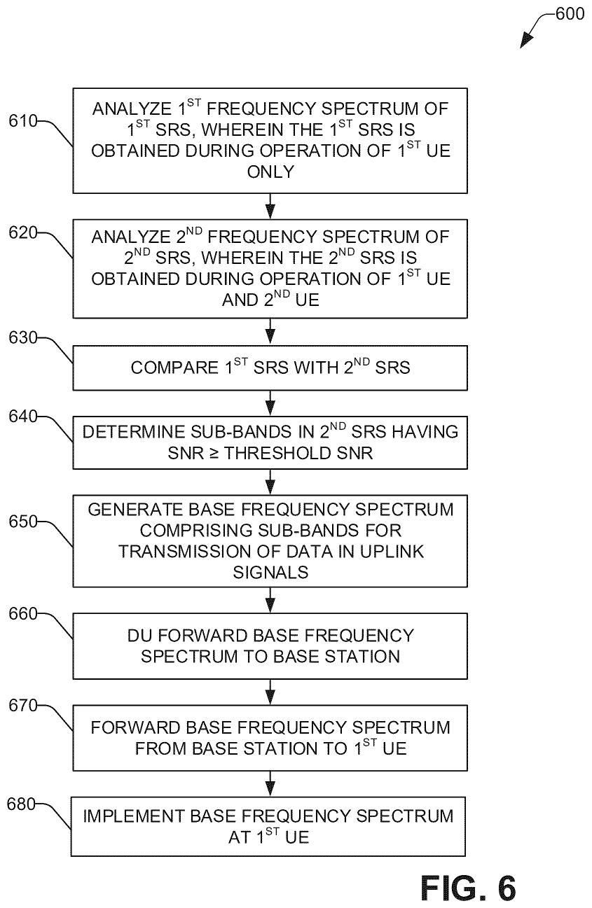

FIG. 6, via flowchart 600, presents a computer-implemented method for determining sub-bands to transmit data in uplink signals, in accordance with an embodiment.

At 610, an interference component (e.g., DU interference component 114) at a DU (e.g., DU 105A) can be configured to process a first SRS (e.g., SRS 129A) to analyze a first frequency spectrum and included sub-bands (e.g., first frequency spectrum 143A and sub-bands A-J) with regard to SNR/SINR of the respective sub-bands. The first SRS is received from first UE (e.g., UE 140B) instructed to transmit the SRS while a second UE (e.g., UE 140A) is instructed not to transmit any SRS or uplink signals (e.g., uplink signals 126A1-n).

At 620, the DU interference component can be further configured to process a second SRS (e.g., SRS 129B) to analyze a second frequency spectrum and included sub-bands (e.g., second frequency spectrum 143B and sub-bands A-J) with regard to SNR of the respective sub-bands.

At 630, the DU interference component can be further configured to compare the first frequency spectrum and included sub-bands with the second frequency spectrum and included sub-bands.

At 640, the DU interference component can be further configured to determine for the second frequency spectrum, sub-bands having an SNR equal or greater to a threshold SNR (e.g., threshold 167T).

At 650, the DU interference component can be configured to generate and transmit a base frequency spectrum (e.g., frequency spectrum 143X and sub-bands A-J) identifying sub-bands on which data is to be transmitted by the first UE (e.g., UE 140B) in uplink signals (e.g., uplink signals 126B1-n) to a base station (e.g., second base station 122B) serving the first UE.

At 660, a signal component (e.g., DU signal component 112) at the DU is configured to receive and forward the base frequency spectrum to the serving base station (e.g., base station 122B) of the first UE (e.g., UE 140B) with an instruction to utilize the base frequency spectrum at the first UE.

At 670, a signal component (e.g., node signal component 412B) can be configured to receive the base frequency spectrum and forward the base frequency spectrum to the first UE.

At 680, a signal component (e.g., UE signal component 450B) can be configured to receive and implement the base frequency spectrum for transmission of uplink signals (e.g., uplink signals 126A-n) from the first UE to the base station.

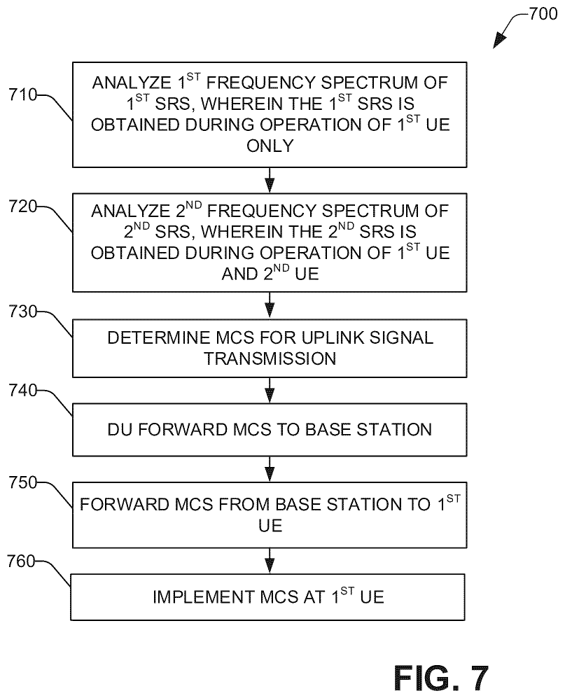

FIG. 7, via flowchart 700, presents a computer-implemented method for determining application of a modulation and coding scheme (MCS) to transmit data in uplink signals, in accordance with an embodiment.

At 710, an interference component (e.g., DU interference component 114) at a DU (e.g., DU 105A) can be configured to process a first SRS (e.g., SRS 129A) to analyze a first frequency spectrum and included sub-bands (e.g., first frequency spectrum 143A and sub-bands A-J) with regard to SNR of the respective sub-bands. The first SRS is received from first UE (e.g., UE 140B) instructed to transmit the SRS while a second UE (e.g., UE 140A) is instructed not to transmit any SRS or uplink signals (e.g., uplink signals 126A1-n). The interference component can be further configured to determine a first MCS score (e.g., MCS score 160A) for the first frequency spectrum.

At 720, the DU interference component can be further configured to process a second SRS (e.g., SRS 129B) to analyze a second frequency spectrum and included sub-bands (e.g., second frequency spectrum 143B and sub-bands A-J) with regard to SNR of the respective sub-bands. The interference component can be further configured to determine a second MCS score (e.g., MCS score 160B) for the second frequency spectrum.

At 730, the DU interference component can be further configured to determine an MCS (e.g., MCS 162A) for application when sending data via uplink signals (e.g., uplink signals 126B1-n) transmitted from the first UE (e.g., UE 140B). The selected MCS is based on the second MCS score versus a threshold MCS value. As previously mentioned, thresholds can range from 0-5, with a high data schema (e.g., 256 QAM used for a high MCS score, QPSK used for a lesser score).

At 740, a signal component (e.g., DU signal component 112) at the DU is configured to receive and forward the implemented MCS to the serving base station (e.g., base station 122B) of the first UE (e.g., UE 140B) with an instruction to utilize the base frequency spectrum at the first UE.

At 750, a signal component (e.g., node signal component 412B) can be configured to receive the implemented MCS and forward the implemented MCS to the first UE.

At 760, a signal component (e.g., UE signal component 150B) can be configured to receive and implement the MCS for transmission of uplink signals (e.g., uplink signals 126A-n) from the first UE to the base station.

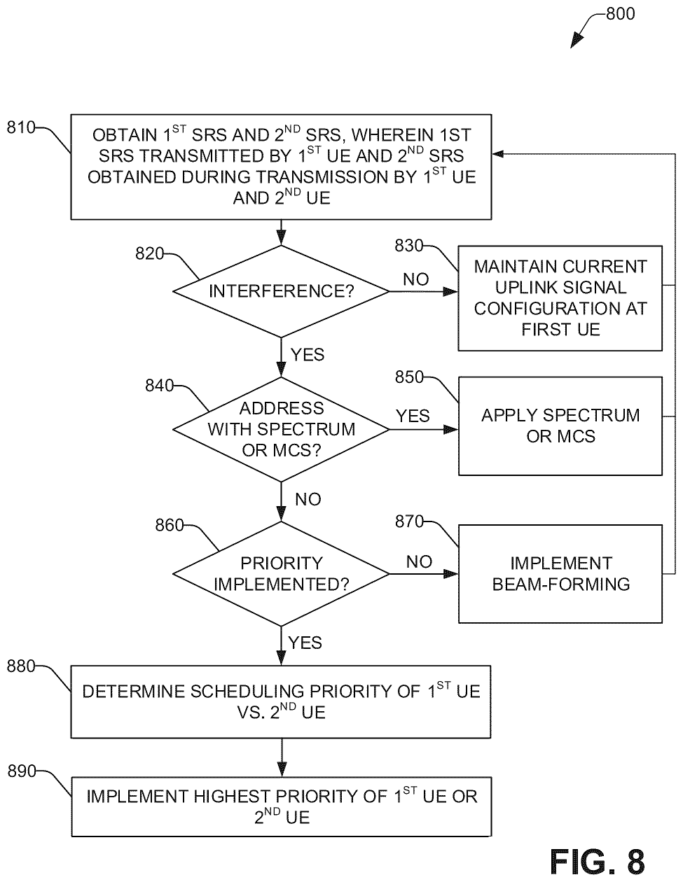

FIG. 8, via flowchart 800, presents a computer-implemented method for mitigating interference of uplink signals, in accordance with an embodiment.

At 810, a first SRS (e.g., SRS 129B1) and a second SRS (e.g., SRS 129B2) are received from a first UE (e.g., UE 140B). The first SRS is transmitted when only the first UE is scheduled to transmit. The second SRS is transmitted when the first UE is scheduled to transmit in conjunction with signaling (e.g., SRS 129A1 or uplink signal 126A1) transmitted from a second UE (e.g., UE 140A). The first SRS includes a first frequency spectrum (e.g., a first frequency spectrum 143B1) generated by the first UE only, while the second SRS includes a second frequency spectrum (e.g., a second frequency spectrum 143B2) generated by the first UE during signal transmission from the second UE.

At 820, a determination (e.g., by DU interference component 114A-n) can be made regarding whether signals on the uplink channel of the second device interfered with the SRSs (e.g., SRS 129B2) on the uplink channel of the first device. In response to a determination that NO inference is occurring, method 800 can advance to step 830, whereupon the current uplink configurations can be maintained. Method 800 can further return to step 810 for a subsequent determination of interference occurring.

At 820, in response to a determination (e.g., by DU interference component 114A-n) that YES, interference is occurring with the SRS, method 800 can advance to step 840, whereupon a determination can be made regarding whether the interference can be addressed with a defined frequency spectrum (e.g., a base frequency spectrum 143B3 having sub-bands A-J to be utilized) or with implementing a defined MCS (e.g., MCS 162A-n).

At 840, in response to a determination (e.g., by DU interference component 114A-n) that YES, the interference can be addressed with a defined frequency spectrum or a defined MCS, method 800 can advance to step 850, whereupon the respective frequency spectrum or the defined MCS can be implemented. Method 800 can further return to step 810 for a subsequent determination of interference occurring.

At 840, in response to a determination (e.g., by DU interference component 114A-n) that NO, the interference cannot be addressed with a defined frequency spectrum or a defined MCS, method 800 can advance to step 860.

At 860, a determination can be performed regarding whether the uplink signals (e.g., uplink signals 126A-n) from the first UE have been prioritized over the second UE, or vice-versa. In response to a determination (e.g., by DU signal component 112A-n) that NO, no priority scheduling has been assigned and/or application of priority would not address the interference, method 800 can advance to step 870, whereupon beam-forming and directional transmission of uplink signals from the first UE and/or the second UE can be implemented. Method 800 can further return to step 810 for a subsequent determination of interference occurring.

At 860, in response to a determination (e.g., by DU signal component 112) that YES, priority scheduling has been assigned, method 800 can advance to step 880 whereupon a determination can be made (e.g., by DU signal component 112A-n, node signal component 412A-n, etc.) regarding whether uplink signal transmission from the first UE has been assigned priority over the second UE, or vice versa. As previously mentioned, priority scores (e.g., priority 134A-n) can be assigned to the first UE and the second UE, whereby the highest priority score/setting wins. Alternatively, the first UE or the second UE can have a constant setting of being prioritized.

At 890, based on the foregoing determination, uplink signaling from the prioritized 1^{st} UE or 2^{nd} UE is implemented. Method 800 can return to step 810 to subsequently determine if interference is occurring (e.g., between the first UE, the second UE, a third UE, etc.) for subsequent mitigation.

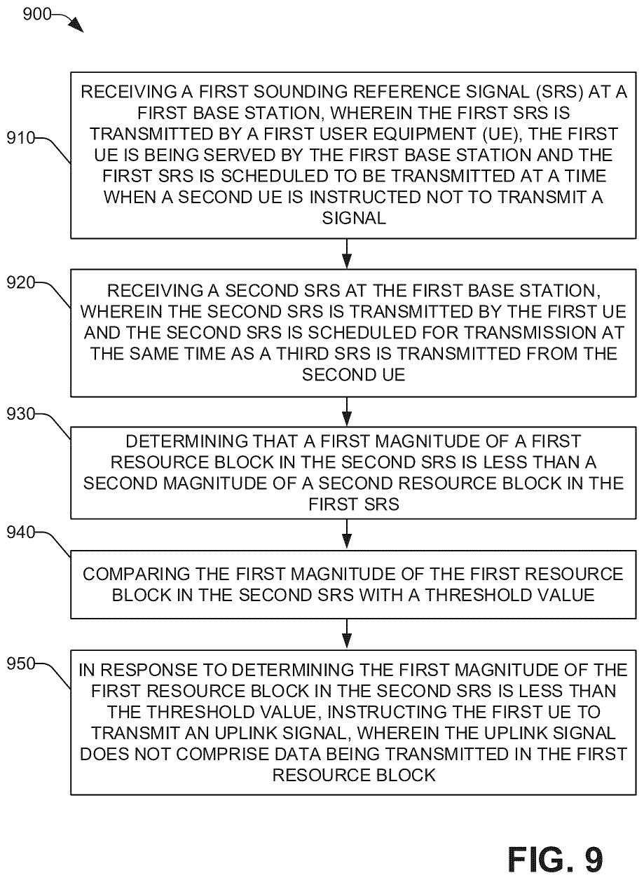

FIG. 9 illustrates a block flow diagram for a system 900 associated with identifying and mitigating interference of uplink signals on a RAN, in accordance with one or more embodiments presented herein. At 910, the process 900 can comprise a system comprising a distribution unit (DU) deployable in a radio access network (RAN), wherein the system further comprising at least one processor (e.g., processor 181), and a memory (e.g., memory 182) coupled to the at least one processor and having instructions stored thereon, wherein, in response to the at least one processor executing the instructions, the instructions facilitate performance of operations, comprising receiving a first SRS (e.g., SRS 129B1) at a first base station (e.g., base station 122B), wherein the first SRS is transmitted by a first user equipment (UE) (e.g., UE 140B), the first UE is being served by the first base station and the first SRS is scheduled to be transmitted at a time when a second UE (e.g., UE 140A) is instructed not to transmit a signal. At 920, the process 900 can further comprise receiving a second SRS (e.g., SRS 129B2) at the first base station, wherein the second SRS is transmitted by the first UE and the second SRS is scheduled for transmission at the same time as a third SRS (e.g., SRS 129A1) is transmitted from the second UE. At 930, the process 900 can further comprise determining that a first magnitude of a first resource block (e.g., signal quality 166A-n of frequency spectrum 143A sub-band A) in the second SRS is less than a second magnitude of a second resource block in the first SRS (e.g., signal quality 166A-n of frequency spectrum 143B sub-band A). At 940, the process 900 can further comprise comparing the first magnitude of the first resource block in the second SRS with a threshold value (e.g., threshold signal quality 167T). At 950, in response to determining the first magnitude of the first resource block in the second SRS is less than the threshold value, instructing the first UE to transmit an uplink signal (e.g., uplink signal 126A-n), wherein the uplink signal does not comprise data being transmitted in the first resource block.

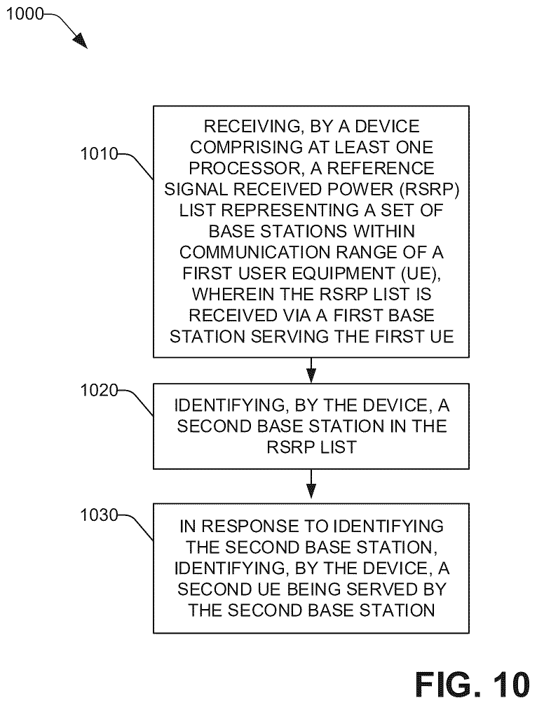

FIG. 10 illustrates a block flow diagram for a process 1000 associated with identifying and mitigating interference of uplink signals on a RAN, in accordance with one or more embodiments presented herein. At 1010, the process 1000 can comprise receiving, by a device (e.g., DU 105) comprising at least one processor, a reference signal received power (RSRP) list (e.g., RSRP list 154A-n) representing a set of base stations (e.g., base stations 122A-n) within communication range of a first user equipment (UE) (e.g., UE 140A), wherein the RSRP list is received via a first base station (e.g., base station 122A) serving the first UE. At 1020, the process 1000 can further comprise identifying, by the device, a second base station (e.g., base station 122B) in the RSRP list. At 1030, the process 1000 can further comprise, in response to identifying the second base station, identifying, by the device, a second UE (e.g., UE 140B) being served by the second base station.

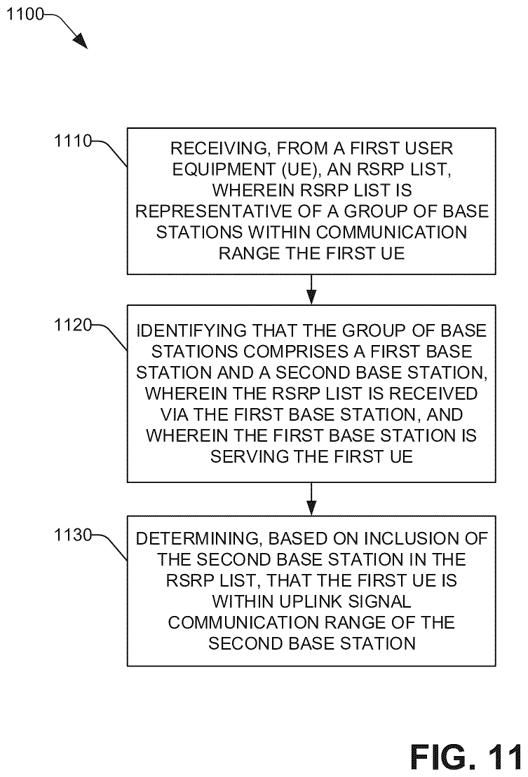

FIG. 11, illustrates a block flow diagram for a process 1100 associated with identifying and mitigating interference of uplink signals on a RAN, in accordance with one or more embodiments presented herein. At 1110, the process 1100 can be performed by a computer program product stored on a non-transitory computer-readable medium and comprising machine-executable instructions, wherein, in response to being executed, the machine-executable instructions cause a system that is part of a radio access network (RAN) to perform operations, comprising receiving, from a first user equipment (UE) (e.g., UE 140A), an RSRP list (e.g., RSRP list 154A-n), wherein RSRP list is representative of a group of base stations (e.g., base stations 122A-n) within communication range the first UE. At 1120, the process 1100 can further comprise identifying that the group of base stations comprises a first base station (e.g., base station 122A) and a second base station (e.g., base station 122B), wherein the RSRP list is received via the first base station (e.g., base station 122A), and wherein the first base station is serving the first UE. At 1130, the process 1100 can further comprise determining, based on inclusion of the second base station in the RSRP list, that the first UE is within uplink signal (e.g., uplink signals 126A-n) communication range of the second base station.

### 9. EXAMPLE ENVIRONMENTS OF USE

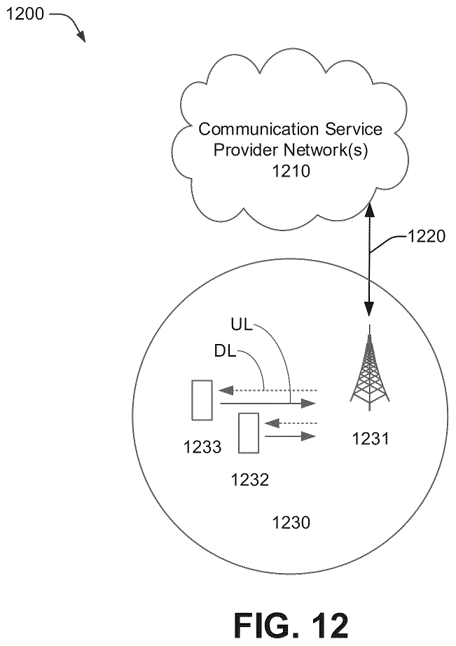

FIG. 12 illustrates an example wireless communication system 1200, in accordance with one or more embodiments described herein. The example wireless communication system 1200 comprises communication service provider network(s) 1210, a network node 1231, and user equipment (UEs) 1232, 1233. A backhaul link 1220 connects the communication service provider network(s) 1210 and the network node 1231. The network node 1231 can communicate with UEs 1232, 1233 within its service area 1230. The dashed arrow lines from the network node 1231 to the UEs 1232, 1233 represent downlink (DL) communications to the UEs 1232, 1233. The solid arrow lines from the UEs 1232, 1233 to the network node 1231 represent uplink (UL) communications.

In general, with reference to FIG. 12, the non-limiting term “user equipment” can refer to any type of device that can communicate with network node 1231 in a cellular or mobile communication system 1200. UEs 1232, 1233 can have one or more antenna panels having vertical and horizontal elements. Examples of UEs 1232, 1233 comprise target devices, device to device (D2D) UEs, machine type UEs or UEs capable of machine to machine (M2M) communications, personal digital assistants (PDAs), tablets, mobile terminals, smart phones, laptop mounted equipment (LME), universal serial bus (USB) dongles enabled for mobile communications, computers having mobile capabilities, mobile devices such as cellular phones, laptops having laptop embedded equipment (LEE, such as a mobile broadband adapter), tablet computers having mobile broadband adapters, wearable devices, virtual reality (VR) devices, heads-up display (HUD) devices, smart cars, machine-type communication (MTC) devices, augmented reality head mounted displays, and the like. UEs 1232, 1233 can also comprise IOT devices that communicate wirelessly.

In various embodiments, system 1200 comprises communication service provider network(s) 1210 serviced by one or more wireless communication network providers. Communication service provider network(s) 1210 can comprise a “core network”. In example embodiments, UEs 1232, 1233 can be communicatively coupled to the communication service provider network(s) 1210 via a network node 1231. The network node 1231 can communicate with UEs 1232, 1233, thus providing connectivity between the UEs 1232, 1233 and the wider cellular network. The UEs 1232, 1233 can send transmission type recommendation data to the network node 1231. The transmission type recommendation data can comprise a recommendation to transmit data via a closed loop multiple input multiple output (MIMO) mode and/or a rank-1 precoder mode.

Network node 1231 can have a cabinet and other protected enclosures, computing devices, an antenna mast, and multiple antennas for performing various transmission operations (e.g., MIMO operations) and for directing/steering signal beams. Network node 1231 can comprise one or more base station devices which implement features of the network node. Network nodes can serve several cells, depending on the configuration and type of antenna. In example embodiments, UEs 1232, 1233 can send and/or receive communication data via wireless links to the network node 1231.

Communication service provider networks 1210 can facilitate providing wireless communication services to UEs 1232, 1233 via the network node 1231 and/or various additional network devices (not shown) included in the one or more communication service provider networks 1210. The one or more communication service provider networks 1210 can comprise various types of disparate networks, including but not limited to: cellular networks, femto networks, picocell networks, microcell networks, internet protocol (IP) networks Wi-Fi service networks, broadband service network, enterprise networks, cloud-based networks, millimeter wave networks and the like. For example, in at least one implementation, system 1200 can be or comprise a large-scale wireless communication network that spans various geographic areas. According to this implementation, the one or more communication service provider networks 1210 can be or comprise the wireless communication network and/or various additional devices and components of the wireless communication network (e.g., additional network devices and cell, additional UEs, network server devices, etc.).

The network node 1231 can be connected to the one or more communication service provider networks 1210 via one or more backhaul links 1220. The one or more backhaul links 1220 can comprise wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 1220 can also comprise wireless link components, such as but not limited to, line-of-sight (LOS) or non-LOS links which can comprise terrestrial air-interfaces or deep space links (e.g., satellite communication links for navigation). Backhaul links 1220 can be implemented via a “transport network” in some embodiments. In another embodiment, network node 1231 can be part of an integrated access and backhaul network. This may allow easier deployment of a dense network of self-backhauled 5G cells in a more integrated manner by building upon many of the control and data channels/procedures defined for providing access to UEs 1232, 1233.

Wireless communication system 1200 can employ various cellular systems, technologies, and modulation modes to facilitate wireless radio communications between devices (e.g., the UEs 1232, 1233 and the network node 1231). While example embodiments might be described for 5G new radio (NR) systems, the embodiments can be applicable to any radio access technology (RAT) or multi-RAT system where the UE operates using multiple carriers, e.g., LTE FDD/TDD, GSM/GERAN, CDMA2000 etc.

For example, system 1200 can operate in accordance with any 5G, next generation communication technology, or existing communication technologies, various examples of which are listed supra. In this regard, various features and functionalities of system 1200 are applicable where the devices (e.g., the UEs 1232, 1233 and the network node 1231) of system 1200 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the UE. The term carrier aggregation (CA) is also called (e.g., interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, system 1200 can be configured to provide and employ 5G or subsequent generation wireless networking features and functionalities. 5G wireless communication networks are expected to fulfill the demand of exponentially increasing data traffic and to allow people and machines to enjoy gigabit data rates with virtually zero (e.g., single digit millisecond) latency. Compared to 4G, 5G supports more diverse traffic scenarios. For example, in addition to the various types of data communication between conventional UEs (e.g., phones, smartphones, tablets, PCs, televisions, internet enabled televisions, AR/VR head mounted displays (HMDs), etc.) supported by 4G networks, 5G networks can be employed to support data communication between smart cars in association with driverless car environments, as well as machine type communications (MTCs). Considering the drastic different communication needs of these different traffic scenarios, the ability to dynamically configure waveform parameters based on traffic scenarios while retaining the benefits of multi carrier modulation schemes (e.g., OFDM and related schemes) can provide a significant contribution to the high speed/capacity and low latency demands of 5G networks. With waveforms that split the bandwidth into several sub-bands, different types of services can be accommodated in different sub-bands with the most suitable waveform and numerology, leading to an improved spectrum utilization for 5G networks.

To meet the demand for data centric applications, features of 5G networks can comprise: increased peak bit rate (e.g., 20 Gbps), larger data volume per unit area (e.g., high system spectral efficiency—for example about 3.5 times that of spectral efficiency of long term evolution (LTE) systems), high capacity that allows more device connectivity both concurrently and instantaneously, lower battery/power consumption (which reduces energy and consumption costs), better connectivity regardless of the geographic region in which a user is located, a larger numbers of devices, lower infrastructural development costs, and higher reliability of the communications. Thus, 5G networks can allow for: data rates of several tens of megabits per second should be supported for tens of thousands of users, 1 gigabit per second to be offered simultaneously to tens of workers on the same office floor, for example, several hundreds of thousands of simultaneous connections to be supported for massive sensor deployments; improved coverage, enhanced signaling efficiency; reduced latency compared to LTE.

The 5G access network can utilize higher frequencies (e.g., >6 GHz) to aid in increasing capacity. Currently, much of the millimeter wave (mmWave) spectrum, the band of spectrum between 30 GHz and 300 GHz is underutilized. The millimeter waves have shorter wavelengths that range from 9 millimeters to 1 millimeter, and these mmWave signals experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the 3GPP and has been in use (including with LTE), is a multi-antenna technique that can improve the spectral efficiency of transmissions, thereby significantly boosting the overall data carrying capacity of wireless systems. The use of MIMO techniques can improve mmWave communications and has been widely recognized as a potentially important component for access networks operating in higher frequencies. MIMO can be used for achieving diversity gain, spatial multiplexing gain and beamforming gain. For these reasons, MIMO systems are an important part of the 3rd and 4th generation wireless systems and are in use in 5G systems.

In order to provide additional context for various embodiments described herein, FIG. 15 and the following discussion are intended to provide a brief, general description of a suitable computing environment 1500 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

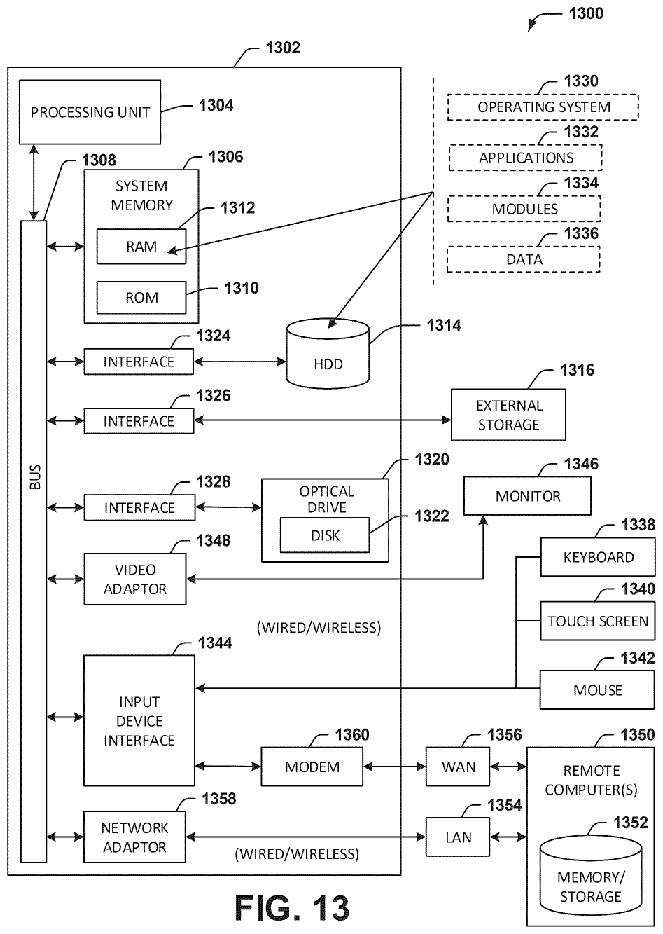

With reference to FIG. 13, the example environment 1300 for implementing various embodiments of the aspects described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors and may include a cache memory. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and an optical disk drive 1350 (e.g., which can read or write from a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid-state drive (SSD) could be used in addition to, or in place of, an HDD 1314. The HDD 1314, external storage device(s) 1316 and optical disk drive 1350 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can comprise a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are examples and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities. The terms “set” and “group” are used interchangeably herein.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G, O-RAN, or other generation networks, the disclosed aspects are not limited to 5G or O-RAN implementations, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system comprising a distribution unit (DU) deployable in a radio access network (RAN), comprising:
at least one processor; and
at least one memory coupled to the at least one processor and having instructions stored thereon, wherein, in response to the at least one processor executing the instructions, the instructions facilitate performance of operations, comprising:
receiving a first sounding reference signal (SRS) at a first base station, wherein the first SRS is transmitted by a first user equipment (UE), the first UE is being served by the first base station and the first SRS is scheduled to be transmitted at a time when a second UE is instructed not to transmit a signal;
receiving a second SRS at the first base station, wherein the second SRS is transmitted by the first UE and the second SRS is scheduled for transmission at the same time as a third SRS is transmitted from the second UE;
determining that a first magnitude of a first resource block in the second SRS is less than a second magnitude of a second resource block in the first SRS;
comparing the first magnitude of the first resource block in the second SRS with a threshold value; and
in response to determining the first magnitude of the first resource block in the second SRS is less than the threshold value, instructing the first UE to transmit an uplink signal, wherein the uplink signal does not comprise data being transmitted in the first resource block.

2. The system of claim 1, wherein the operations further comprise:
in response to determining that the first magnitude of the first resource block in the second SRS is equal to or greater than the threshold value, instructing the first UE to transmit the uplink signal, wherein the uplink signal comprises data being transmitted in the first resource block.

3. The system of claim 1, wherein the second UE is served by a second base station, and wherein the first base station and second base station are disparate base stations.

4. The system of claim 1, wherein the first base station is communicatively coupled to the DU, and wherein the second base station is communicatively coupled to the DU.

5. The system of claim 1, wherein the operations further comprise:
prior to receiving the first SRS, instructing a group of base stations communicatively coupled to the DU to respectively transmit a reference downlink signal; and
receiving a reference signal received power (RSRP) list from the second UE, wherein the RSRP list comprises a first signal strength of a first downlink signal generated by the first base station and a second signal strength of a second downlink signal generated by the second base station.

6. The system of claim 5, wherein the operations further comprise:
determining that the second UE is included in the RSRP list, wherein inclusion of the second UE in the RSRP list indicates that the second UE is in range of the first base station; and
in response to determining the second UE is included in the RSRP list, instructing the second UE to transmit the third SRS when the first UE transmits the second SRS at the first base station.

7. The system of claim 5, wherein the RSRP list ranks the first base station and the second base station based on the first signal strength of the first downlink signal and the second signal strength of the second downlink signal, and wherein the first signal strength of the first downlink is greater than the second signal strength of the second downlink signal.

8. The system of claim 1, wherein the DU is located in a first data server and communicatively coupled to a second data server, and wherein the first base station is communicatively coupled to the first data server via the second data server.

9. The system of claim 1, wherein the operations further comprise:
determining a modulation and coding scheme (MCS) score for a portion of a frequency spectrum included in the second SRS;
identifying an MCS corresponding to the MCS score; and
instructing the second UE to transmit an uplink signal utilizing the MCS.

10. A computer-implemented method comprising:
receiving, by a device comprising at least one processor, a reference signal received power (RSRP) list representing a set of base stations within communication range of a first user equipment (UE), wherein the RSRP list is received via a first base station serving the first UE;
identifying, by the device, a second base station in the RSRP list; and
in response to identifying the second base station, identifying, by the device, a second UE being served by the second base station.

11. The computer-implemented method of claim 10, further comprising:
instructing, by the device, the second UE to transmit a first sounding reference signal (SRS), wherein the first UE is not scheduled to transmit an uplink signal during transmission of the first SRS;
instructing, by the device, the second UE to transmit a second SRS and the first UE to transmit a third SRS, wherein transmission of the second SRS is scheduled to coincide with transmission of the third SRS; and
determining, by the device, whether operation of the first UE is interfering with operation of the second UE.

12. The computer-implemented method of claim 11, further comprising:
determining, by the device, a first signal to noise ratio (SNR) of a portion of a first frequency spectrum included in the second SRS;
comparing, by the device, the first SNR with a threshold SNR; and
in response to a determination that the first SNR is less than the threshold SNR, instructing, by the device, the second UE not to transmit data in the portion of the first frequency spectrum.

13. The computer-implemented method of claim 12, further comprising:
in response to a determination that the first SNR is equal to or greater than the threshold SNR, instructing, by the device, the second UE to transmit data in the portion of the first frequency spectrum.

14. The computer-implemented method of claim 11, further comprising:
determining, by the device, a modulation and coding scheme (MCS) score for a portion of a first frequency spectrum included in the second SRS;
identifying, by the device, an MCS corresponding to the MCS score; and
instructing, by the device, the second UE to transmit an uplink signal utilizing the MCS.

15. The computer-implemented method of claim 14, wherein the MCS specified one of quadrature amplitude modulation or quadrature phase shift keying.

16. A computer program product stored on a non-transitory computer-readable medium and comprising machine-executable instructions, wherein, in response to being executed, the machine-executable instructions cause a system that is part of a radio access network (RAN) to perform operations, comprising:
receiving, from a first user equipment (UE), an RSRP list, wherein RSRP list is representative of a group of base stations within communication range the first UE;
identifying that the group of base stations comprises a first base station and a second base station, wherein the RSRP list is received via the first base station, and wherein the first base station is serving the first UE; and
determining, based on inclusion of the second base station in the RSRP list, that the first UE is within uplink signal communication range of the second base station.

17. The computer program product according to claim 16, wherein the system is a distributed unit communicatively coupled to the first base station and the second base station, and wherein the operations further comprise:
identifying a second UE communicatively coupled to the second base station;
receiving, via the second base station, a first SRS generated by the second UE, wherein the first SRS was scheduled for transmission when the first UE is not transmitting an uplink signal;
receiving, via the second base station, a second SRS generated by the second UE, wherein the second SRS is transmitted at a same time as an uplink signal is transmitted by the first UE to the first base station;
comparing first content of the first SRS with second content of the second SRS; and
determining, based on the first content of the first SRS being determined to be different from the second content of the second SRS, that uplink signaling performed by the first UE is interfering with uplink signaling performed by the second UE.

18. The computer program product according to claim 17, wherein the operations further comprise:
determining, based on the first content of the first SRS being determined to be same content as the second content of the second SRS, that uplink signaling performed by the first UE is not interfering with uplink signaling performed by the second UE.

19. The computer program product according to claim 17, wherein the operations further comprise:
determining a signal to noise ratio (SNR) of a portion of a frequency band in the second SRS; and
in response to determining the SNR of the portion of the frequency band is less than a defined threshold, instructing the second UE not to subsequently transmit data using the portion of the frequency band.

20. The computer program product according to claim 17, wherein the operations further comprise:
determining a modulation and coding scheme (MCS) score for the second SRS;
identifying an MCS assigned to the MCS score; and
instructing the second UE to implement the MCS for transmission of data in an uplink signal.
